(19) United States
(12) Patent Application Publication
(10) Pub. No.: US 2017/0275189 A1
(43) Pub. Date: Sep. 28, 2017

(54) DEPOSIT MONITORING DEVICE FOR WATER TREATMENT DEVICE, WATER TREATMENT DEVICE, OPERATING METHOD FOR SAME, AND WASHING METHOD FOR WATER TREATMENT DEVICE

(71) Applicant: MITSUBISHI HEAVY INDUSTRIES, LTD., Tokyo (JP)

(72) Inventors: Hideaki Sakurai, Tokyo (JP); Hideo Suzuki, Tokyo (JP); Hiroshi Nakashoji, Tokyo (JP); Shigeru Yoshioka, Tokyo (JP); Susumu Okino, Tokyo (JP); Noriaki Senba, Tokyo (JP); Shigehiro Sugiyama, Tokyo (JP); Masayuki Eda, Tokyo (JP); Hyota Abe, Tokyo (JP); Ryo Kamito, Tokyo (JP); Nobuyuki Ukai, Tokyo (JP)

(73) Assignee: MITSUBISHI HEAVY INDUSTRIES, LTD., Tokyo (JP)

(21) Appl. No.: 15/505,697

(22) PCT Filed: Sep. 3, 2014
(86) PCT No.: PCT/JP2014/073236

§ 371 Date: Feb. 22, 2017

(51) Int. Cl. C02F 1/44; B01D 65/06; B01D 65/10

(52) U.S. Cl. CPC C02F 1/44; B01D 65/10; B01D 65/06; C02F 1/447; C02F 1/445; C02F 1/442; C02F 1/441

(57) ABSTRACT

A deposit monitoring device includes a non-permeated water line discharging non-permeated water where dissolved components and dispersed components are concentrated from water to be treated from a separation membrane device for obtaining permeated water by concentrating the dissolved components and dispersed components from water to be treated by a separation membrane; a first deposit detecting unit using part of the non-permeated water branched off as a detection liquid, and having a first separation membrane for detection in which the detection liquid is separated into permeated water for detection and non-permeated water for detection; a deposition condition altering device altering deposition conditions for deposits in the first separation membranes for detection; and first flow rate measuring devices for separated liquid detection that measure the flow rates of one or both of the permeated water for detection and the non-permeated water for detection separated by the first separation membrane for detection.

### TECHNICAL FIELD

The present invention relates to a deposit monitoring device for a water treatment device, a water treatment device, an operating method for the same, and a washing method for a water treatment device.

### BACKGROUND ART

For example, mining wastewater contains pyrite (FeS₂), and, when this pyrite is oxidized, SO₄²⁻ is generated. In order to neutralize mining wastewater, inexpensive Ca(OH)₂ is used. Therefore, mining wastewater contains a rich amount of Ca²⁺ and SO₄²⁻.

In addition, it is known that brine water, sewage water, and industrial wastewater also contain a rich amount of Ca²⁺ and SO₄²⁻. In addition, in cooling towers, heat exchange occurs between high-temperature exhaust gas discharged from boilers and the like and cooling water. Since some of cooling water turns into vapor due to this heat exchange, ions are concentrated in cooling water. Therefore, cooling water discharged from cooling towers (blow-down water) is in a state in which the ion concentrations of Ca²⁺, SO₄²⁻, and the like are high.

Water containing a large amount of these ions is subjected to a desalination treatment. As a concentration device for carrying out the desalination treatment, for example, reverse osmosis membrane devices, nanofiltration membrane devices, ion-exchange membrane devices, and the like are known.

However, while the desalination treatment is carried out using the above-described devices, if a high concentration of a cation (for example, a calcium ion (Ca²⁺)) and an anion (for example, a sulfate ion (SO₄²⁻)) concentrate on membrane surfaces when fresh water is obtained, there are cases in which the concentration of the ions exceeds the solubility limit of calcium sulfate (gypsum (CaSO₄)) which is a poorly-soluble mineral salt, and there is a problem in that the ions are precipitated on membrane surfaces as deposits and the permeation rate (flux) of fresh water decreases.

Therefore, in the related art, as monitoring methods for reverse osmosis membranes, for example, a method in which the generation of the crystals of mineral salts is detected by means of visual determination using cells for monitoring reverse osmosis membranes in reverse osmosis membrane devices has been proposed (PTL 1).

In addition, a method in which at least part of concentrated water from a water conversion device is permeated through a separation membrane for monitoring and the precipitation of deposits included in the concentrated water on the membrane surfaces of the separation membrane for monitoring is monitored using pressure meters provided before and after the separation membrane for monitoring has been proposed (PTL 2). This proposal enables the early monitoring of the precipitation of deposits on the membrane surfaces of filtration membranes caused by the concentration of raw water (seawater) and the efficient suppression of the precipitation of deposits on the membrane surfaces of filtration membranes in water conversion devices.

In addition, PTL 2 has also proposed the supply of an alkaline medicine to concentrated water supplied from the separation membrane for monitoring in order to promote the precipitation of deposits.

### CITATION LIST

### Patent Literature

[PTL 1] PCT Japanese Translation Patent Publication No. 2009-524521

[PTL 2] Japanese Unexamined Patent Application Publication No. 2010-282469

### SUMMARY OF INVENTION

### Technical Problem

However, in the monitoring method proposed by PTL 1, since whether or not the crystals of mineral salts are precipitated in the cells for monitoring is determined, similarly, the mineral salts are also precipitated in the reverse osmosis membranes, and thus there is a problem in that it is not possible to monitor the symptom of crystal precipitation in advance.

In addition, in the proposal by PTL 2, since it is necessary to detect a pressure difference before and after the cell for monitoring, there is a problem in that it is not possible to determine the precipitation of deposits until a large amount of the deposits are precipitated and thus flow channels are clogged with the deposits and the pressure difference changes. In addition, in order to detect deposits, monitoring devices need to be approximately as large as, for example, filtration membranes in water conversion devices for raw water, and thus there is a problem in that monitoring devices become large.

That is, regarding a reverse osmosis membrane in a water conversion device, in a case in which one vessel for filtration is constituted by, for example, storing a plurality (for example, five to eight) of one meter-long spiral membranes and the filtration of raw water is carried out by linking several hundreds of vessels, the compactization of monitoring devices contributes to the compactization of water conversion facilities, and thus there is a desire for the emergence of monitoring devices for deposits which are capable of becoming as compact as possible.

In addition, in a case in which an alkaline medicine is supplied, the supply of the alkaline medicine is effective for deposit components which become easily precipitated due to the supply of the alkaline medicine (for example, calcium carbonate, magnesium hydroxide, and the like), but is not effective for components that do not depend on the pH (for example, gypsum (CaSO₄), calcium fluoride (CaF₂), and the like), and thus there is a problem in that it is not possible to apply the supply of the alkaline medicine to concentrated water.

The present invention has been made in consideration of the above-described problems, and an object of the present invention is to provide a deposit monitoring device for a water treatment device in which the deposition of deposits not only in reverse osmosis membranes in reverse osmosis membrane devices but also in separation membranes in separation membrane devices can be predicted using a compact device, a water treatment device, an operating method for the same, and a washing method for a water treatment device.

### Solution to Problem

A first invention of the present invention for achieving the above-descried object is a deposit monitoring device for a water treatment device being provided with: a non-permeated water line for discharging non-permeated water in which dissolved components and dispersed components are concentrated from a separation membrane device for obtaining permeated water by concentrating the dissolved components and dispersed components from water to be treated by means of a separation membrane; a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection; a deposition condition altering device for altering deposition conditions for deposits in the first separation membrane for detection; and first flow rate measuring devices for separated liquid for detection that measure the flow rates of one or both of the permeated water for detection and the non-permeated water for detection separated by the first separation membrane for detection.

A second invention is a deposit monitoring device for a water treatment device being provided with: a water to be treated supply line for supplying water to be treated to a separation membrane device for obtaining permeated water by concentrating the dissolved components and dispersed components by means of a separation membrane; a second deposit detecting unit provided in a branch line branched from the water to be treated supply line, using part of the water to be treated that has branched off as a detection liquid, and having a second separation membrane for detection in which the detection liquid is separated into permeated water for detection and non-permeated water for detection; a deposition condition altering device for altering deposition conditions for deposits in the second separation membrane for detection; and second flow rate measuring devices for separated liquid for detection that measure the flow rates of one or both of the permeated water for detection and the non-permeated water for detection separated by the second separation membrane for detection.

A third invention is the deposit monitoring device for a water treatment device according to the first or second invention, in which the deposition condition altering device is a pressure adjusting device for altering a supply pressure of the detection liquid that has branched off.

A fourth invention is the deposit monitoring device for a water treatment device according to the first or second invention, in which the deposition condition altering device is a flow rate adjusting device for altering a supply flow rate of the detection liquid that has branched off.

A fifth invention is a water treatment device being provided with: a separation membrane device having a separation membrane for concentrating dissolved components and dispersed components from water to be treated and obtaining permeated water; a non-permeated water line for discharging non-permeated water in which the dissolved components and dispersed components are concentrated from the separation membrane device; a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection; a deposition condition altering device for altering deposition conditions for deposits in the first separation membrane for detection; first flow rate measuring devices for separated liquid for detection that measure the flow rates of one or both of the permeated water for detection and the non-permeated water for detection separated by the first separation membrane for detection; and a control device for carrying out one or both of execution of a washing treatment on the separation membrane in the separation membrane device and a change to an operation condition not allowing deposits to be deposited in the separation membrane of the separation membrane device as a result of measurement of the first flow rate measuring devices for separated liquid for detection.

A sixth invention is a water treatment device being provided with: a separation membrane device having a separation membrane for concentrating dissolved components and dispersed components from water to be treated and obtaining permeated water; a water to be treated supply line for supplying the water to be treated to the separation membrane device; a second deposit detecting unit provided in a water to be treated branch line branched from the water to be treated supply line, using part of the water to be treated that has branched off as a detection liquid, and having a second separation membrane for detection in which the detection liquid is separated into permeated water for detection and non-permeated water for detection; a deposition condition altering device for altering deposition conditions for deposits in the second separation membrane for detection; second flow rate measuring devices for separated liquid for detection that measure the flow rates of one or both of the permeated water for detection and the non-permeated water for detection separated by the second separation membrane for detection; and a control device for carrying out one or both of execution of a washing treatment on the separation membrane in the separation membrane device and a change to an operation condition not allowing deposits to be deposited in the separation membrane of the separation membrane device as a result of measurement of the second flow rate measuring devices for separated liquid for detection.

A seventh invention is a water treatment device being provided with: a separation membrane device having a separation membrane for concentrating dissolved components and dispersed components from water to be treated and obtaining permeated water; a non-permeated water line for discharging non-permeated water in which the dissolved components and dispersed components are concentrated from the separation membrane device; a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection; a deposition condition altering device for altering deposition conditions for deposits in the first separation membrane for detection; first flow rate measuring devices for separated liquid for detection that measure the flow rates of one or both of the permeated water for detection and the non-permeated water for detection separated by the first separation membrane for detection; a water to be treated supply line for supplying the water to be treated to the separation membrane device; a second deposit detecting unit provided in a water to be treated branch line branched from the water to be treated supply line, using part of the non-permeated water that has branched off as a detection liquid, and having a second separation membrane for detection in which the detection liquid is separated into permeated water for detection and non-permeated water for detection; a deposition condition altering device for altering deposition conditions for deposits in the second separation membrane for detection; second flow rate measuring devices for separated liquid for detection that measure the flow rates of one or both of the permeated water for detection and the non-permeated water for detection separated by the second separation membrane for detection; and a control device for carrying out one or both of execution of a washing treatment on the separation membrane in the separation membrane device and a change to an operation condition not allowing deposits to be deposited in the separation membrane of the separation membrane device as a result of measurement of the first flow rate measuring devices for separated liquid for detection or the second flow rate measuring devices for separated liquid for detection.

An eighth invention is the water treatment device according to any one of the fifth to seventh inventions, being provided with an evaporator for evaporating moisture of the non-permeated water from the separation membrane device.

A ninth invention is an operating method for a water treatment device, including: carrying out one or both of execution of a washing treatment on a separation membrane in a separation membrane device and a change to an operation condition not allowing deposits to be deposited in the separation membrane of the separation membrane device in a case in which deposition conditions for deposits in a first separation membrane for detection are changed and a flow rate of permeated water for detection or non-permeated water for detection changes more than a predetermined amount when the permeated water for detection or the non-permeated water for detection separated by the first separation membrane for detection is measured in first flow rate measuring devices for separated liquid for detection using the deposit monitoring device for a water treatment device of the first invention.

A tenth invention is the operating method for a water treatment device according to the ninth invention, in which the change of the deposition conditions for deposits is a change of a supply pressure of the non-permeated water that has branched off, and the supply pressure is equal to or less than a predetermined threshold value.

An eleventh invention is the operating method for a water treatment device according to the ninth invention, in which the change of the deposition conditions for deposits is a change of a supply flow rate of the non-permeated water that has branched off, and the supply flow rate is equal to or more than a predetermined threshold value.

A twelfth invention is an operating method for a water treatment device, including: carrying out one or both of execution of a washing treatment on a separation membrane in a separation membrane device and a change to an operation condition not allowing deposits to be deposited in the separation membrane of the separation membrane device in a case in which deposition conditions for deposits in a second separation membrane for detection are changed and a flow rate of permeated water for detection or non-permeated water for detection also changes from a predetermined amount when the permeated water for detection or the non-permeated water for detection separated by the second separation membrane for detection is measured in the second flow rate measuring device for separated liquid for detection using the deposit monitoring device for a water treatment device of the second invention.

A thirteenth invention is the operating method for a water treatment device according to the twelfth invention, in which the change of the deposition conditions for deposits is a change of a supply pressure of the water to be treated that has branched off, and the supply pressure is equal to or less than a predetermined threshold value.

A fourteenth invention is the operating method for a water treatment device according to the twelfth invention, in which the change of the deposition conditions for deposits is a change of a supply flow rate of the water to be treated that has branched off, and the supply flow rate is equal to or more than a predetermined threshold value.

A fifteenth invention is an operating method for a water treatment device, including: carrying out a change of operation conditions for a separation membrane device in a case in which deposition conditions for deposits in a first separation membrane for detection are changed and a flow rate of permeated water for detection or non-permeated water for detection is maintained at a predetermined amount when the permeated water for detection or the non-permeated water for detection separated by the first separation membrane for detection is measured in first flow rate measuring devices for separated liquid for detection using the deposit monitoring device for a water treatment device of the first invention.

A sixteenth invention is the operating method for a water treatment device according to the fifteenth invention, in which the deposition condition for deposits is a change of a supply pressure of the non-permeated water that has branched off, and the supply pressure is equal to or more than a predetermined threshold value.

A seventeenth invention is the operating method for a water treatment device according to the fifteenth invention, in which the deposition condition for deposits is a change of a supply flow rate of the non-permeated water that has branched off, and the supply flow rate is equal to or less than a predetermined threshold value.

An eighteenth invention is an operating method for a water treatment device, including: carrying out a change of operation conditions for a separation membrane device in a case in which deposition conditions for deposits in a second separation membrane for detection are changed and a flow rate of permeated water for detection or non-permeated water for detection is maintained at a predetermined amount when the permeated water for detection or the non-permeated water for detection separated by the second separation membrane for detection is measured in second flow rate measuring devices for separated liquid for detection using the deposit monitoring device for a water treatment device of the second invention.

A nineteenth invention is the operating method for a water treatment device according to the eighteenth invention, in which the deposition condition for deposits is a change of a supply pressure of the non-permeated water that has branched off, and the supply pressure is equal to or more than a predetermined threshold value.

A twentieth invention is the operating method for a water treatment device according to the eighteenth invention, in which the deposition condition for deposits is a change of a supply flow rate of the non-permeated water that has branched off, and the supply flow rate is equal to or less than a predetermined threshold value.

A twenty first invention is a washing method for a water treatment device, including: selecting a washing liquid suitable to deposits deposited in a first separation membrane for detection in a first deposit detecting unit when a flow rate of permeated water for detection and non-permeated water for detection changes more than a predetermined amount; and supplying the selected washing liquid to a separation membrane device when the permeated water for detection or the non-permeated water for detection separated by the first separation membrane for detection is measured in first flow rate measuring devices for separated liquid for detection using the deposit monitoring device for a water treatment device of the first invention.

A twenty second invention is a washing method for a water treatment device, including: selecting a washing liquid suitable to deposits deposited in a second separation membrane for detection in a second deposit detecting unit when a flow rate of permeated water for detection and non-permeated water for detection changes more than a predetermined amount; and supplying the selected washing liquid to a separation membrane device when the permeated water for detection or the non-permeated water for detection separated by the second separation membrane for detection is measured in second flow rate measuring devices for separated liquid for detection using the deposit monitoring device for the second water treatment device.

A twenty third invention is the operating method for a water treatment device according to the ninth or twelfth invention, in which moisture of the non-permeated water from the separation membrane device is evaporated.

### Advantageous Effects of Invention

According to the present invention, in a case in which water to be treated is treated using a separation membrane device using a separation membrane, it is possible to predict the deposition of deposits in the separation membrane by using a deposit monitoring device for a water treatment device.

### BRIEF DESCRIPTION OF DRAWINGS

FIG. 1 is a schematic view of a desalination treatment device provided with a deposit monitoring device for a desalination treatment device according to Example 1.

FIG. 2 is a schematic view of a first deposit detecting unit according to Example 1.

FIG. 3 is a perspective view of the first deposit detecting unit in FIG. 2.

FIG. 4 is a partially-notched perspective view of a case in which a spiral reverse osmosis membrane is used in the first deposit detecting unit.

FIG. 5 is a partially-notched schematic view of a vessel in a spiral reverse osmosis membrane device.

FIG. 6 is a perspective view of two vessel coupled together.

FIG. 7 is a schematic partially exploded view of an element.

FIG. 8 is a view illustrating the behavior of a flux caused by a change of the supply pressure in a case in which the film length of a reverse osmosis membrane for detection is set to 16 mm under a condition in which the degree of supersaturation of gypsum in a supply liquid in the reverse osmosis membrane for detection is set to be constant.

FIG. 9 is a view illustrating the behavior of the flux caused by a change of the supply pressure in a case in which the film length of the reverse osmosis membrane for detection is set to 1,000 mm under the condition in which the degree of supersaturation of gypsum in the supply liquid in the reverse osmosis membrane for detection is set to be constant.

FIG. 10 is a view illustrating a relationship in a case in which only the supply pressure is changed for detection liquids having different degrees of gypsum supersaturation.

FIG. 11 is a view illustrating the behavior of the flux caused by a change of the supply pressure in a case in which the film length of the reverse osmosis membrane for detection is set to 16 mm under the condition in which the degree of supersaturation of gypsum in the supply liquid in the reverse osmosis membrane for detection is set to be constant.

FIG. 12-1 is a view illustrating an example of controlling the supply pressure of a detection liquid in the present example.

FIG. 12-2 is a view illustrating an example of controlling the supply pressure of the detection liquid in the present example.

FIG. 13 is a view illustrating an example of controlling the supply pressure of the detection liquid in the present example.

FIG. 14 is a view illustrating an example of controlling the supply pressure of the detection liquid in the present example.

FIG. 15 is a view illustrating an example of controlling the supply pressure of the detection liquid in the present example.

FIG. 16 is a view illustrating an example of controlling the supply pressure of the detection liquid in the present example.

FIG. 17 is a view illustrating an example of controlling the supply pressure of the detection liquid in the present example.

FIG. 18 is a view illustrating an example in which three deposit detecting units are provided in non-permeated water branch lines.

FIG. 19 is a view illustrating an example of controlling the supply flow rate of the detection liquid in the present example.

FIG. 20 is a view illustrating an example of controlling the supply flow rate of the detection liquid in the present example.

FIG. 21 is a view illustrating an example of controlling the supply flow rate of the detection liquid in the present example.

FIG. 22 is a view illustrating an example of controlling the supply flow rate of the detection liquid in the present example.

FIG. 23 is a view illustrating an example of controlling the supply flow rate of the detection liquid in the present example.

FIG. 24 is a view illustrating an example of controlling the supply flow rate of the detection liquid in the present example.

FIG. 25 is a schematic view illustrating an example of changing the operation conditions of the desalination treatment device according to Example 1.

FIG. 26 is a schematic view of a desalination treatment device provided with a deposit monitoring device in the desalination treatment device according to Example 2.

FIG. 27 is a schematic view of a desalination treatment device provided with a deposit monitoring device in the desalination treatment device according to Example 3.

FIG. 28 is a schematic view illustrating an example of changing the operation conditions of the desalination treatment device according to Example 3.

FIG. 29 is a schematic view of a desalination treatment device provided with a deposit monitoring device in the desalination treatment device according to Example 4.

FIG. 30 is a schematic view of a desalination treatment device according to Example 5.

### DESCRIPTION OF EMBODIMENTS

Preferred examples of the present invention will be described in detail with reference to the accompanying drawings. Meanwhile, these examples do not limit the present invention, and, in a case in which a plurality of examples are provided, the scope of the present invention includes constitutions obtained by constituting the respective examples.

### Example 1

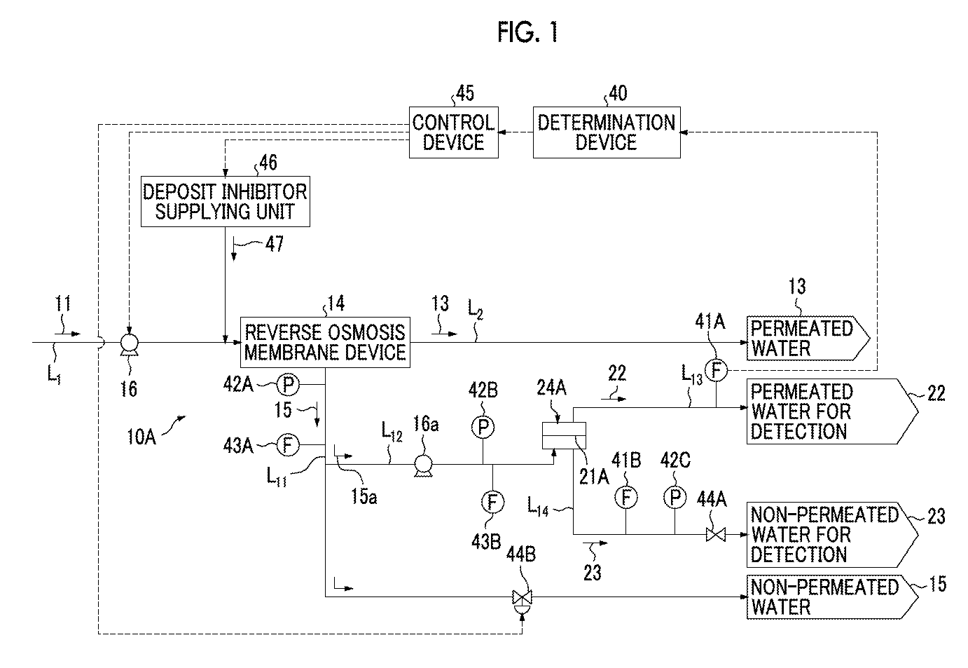

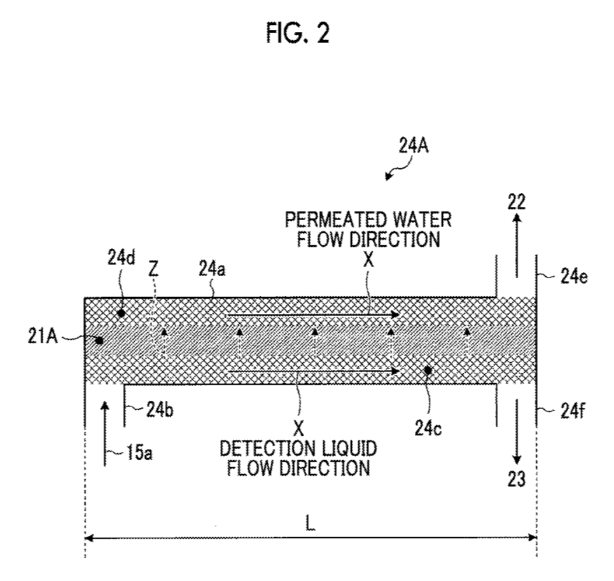

FIG. 1 is a schematic view of a desalination treatment device provided with a deposit monitoring device for a desalination treatment device according to Example 1. FIG. 2 is a schematic view of the deposit monitoring device for a desalination treatment device according to Example 1. In the following example, a reverse osmosis membrane device which is a separation membrane device using a reverse osmosis membrane as a separation membrane will be exemplified, and, for example, a desalination treatment device for desalinating dissolved components such as a saline matter will be described, but the present invention is not limited thereto as long as a subject device is a desalination treatment device for treating water using a separation membrane.

As illustrated in FIG. 1, a desalination treatment device 10A according to the present example is provided with a reverse osmosis membrane device 14 that is a desalination treatment device which has a reverse osmosis membrane for concentrating dissolved components containing ions or organic substances (also referred to as “deposited components”) from water to be treated 11 and obtaining permeated water 13, a first deposit detecting unit 24A provided in a non-permeated water branch line L₁₂ branched from a non-permeated water line L₁₁ for discharging non-permeated water 15 in which the dissolved components containing ions or organic substances are concentrated and having a first reverse osmosis membrane for detection 21A for separating a detection liquid 15a branched from the non-permeated water 15 into permeated water for detection 22 and non-permeated water for detection 23, a deposition condition altering device for altering deposition conditions for deposits in the first reverse osmosis membrane for detection 21A, a first flow rate measuring device for permeated water for detection 41A and a first flow rate measuring device for non-permeated water for detection 41B which are first flow rate measuring devices for separated liquid for detection that measure the flow rates of one or both of the permeated water for detection 22 and the non-permeated water for detection 23 separated by the first reverse osmosis membrane for detection 21A, and a control device 45 for carrying out one or both of execution of a washing treatment on the reverse osmosis membrane in the reverse osmosis membrane device 14 and a change to operation conditions (for example, operation conditions such as the pressure, the flow rate, and the concentration of a deposit inhibitor) not allowing deposits to be deposited in the reverse osmosis membrane device 14 as a result of measurement of the first flow rate measuring devices for separated liquid for detection (the first flow rate measuring device for permeated water for detection 41A and the first flow rate measuring device for non-permeated water for detection 41B). Meanwhile, in FIG. 1, reference sign 16 represents a high-pressure pump for supplying the water to be treated 11 to the reverse osmosis membrane device 14, L₁ represents a water to be treated introduction line, and L₂ represents a permeated water discharge line, respectively.

Here, the reverse osmosis membrane device 14 is a device for producing the permeated water 13 from the water to be treated 11 and thus, hereinafter, will also be referred to as “basic design reverse osmosis membrane device” in some cases.

In the present invention, a determination device 40 for determining that deposit deposition in the reverse osmosis membrane in the basic design reverse osmosis membrane device 14 is predicted as a result of measurement of the first flow rate measuring devices for separated liquid for detection (the first flow rate measuring device for permeated water for detection 41A and the first flow rate measuring device for non-permeated water for detection 41B) is installed, and, when the deposition of deposits in the reverse osmosis membrane in the basic design reverse osmosis membrane device is predicted by the determination in the determination device 40, one or both of execution of a washing treatment on the reverse osmosis membrane in the reverse osmosis membrane device 14 and a change to operation conditions (for example, operation conditions such as the pressure, the flow rate, and the concentration of a deposit inhibitor) not allowing deposits to be deposited in the reverse osmosis membrane device 14 are carried out using the control device 45, but the determination device 40 may be installed as necessary.

Here, as separated liquids separated by the first reverse osmosis membrane for detection 21A, there are permeated water for detection 22 permeating the first reverse osmosis membrane for detection 21A and non-permeated water for detection 23 not permeating the first reverse osmosis membrane for detection 21A. In the present example, as the first flow rate measuring devices for separated liquid for detection, the first flow rate measuring device for permeated water for detection 41A for measuring the flow rate of the permeated water for detection 22 is provided in a permeated water for detection discharge line L₁₃, and the first flow rate measuring device for non-permeated water for detection 41B for measuring the flow rate of the non-permeated water for detection 23 is provided in a non-permeated water for detection discharge line L₁₄.

Meanwhile, as the measuring method for the flow rates using the flow rate measuring devices, the flow rates may be directly measured using a flow instrument, or the flow rates may be indirectly measured by means of a weight measurement using, for example, an electronic weighing machine. In the following example, an example in which a flow instrument is used as the flow rate measuring device will be described.

In addition, the flow rates of one or both of the permeated water for detection 22 and the non-permeated water for detection 23 are measured using the first flow rate measuring device for permeated water for detection 41A and the first flow rate measuring device for non-permeated water for detection 41B.

Here, the total of the flow rates of the permeated water for detection 22 and the non-permeated water for detection 23 is the flow rate of the detection liquid 15a being supplied to the first deposit detecting unit 24A, and thus the flow rate of the permeated water for detection 22 may be indirectly obtained from that of the non-permeated water 23. In the following description, a case in which the flow rate of the non-permeated water for detection 22 is measured using the first flow rate measuring device for permeated water for detection 41A will be mainly described.

Here, regarding the determination condition for determining that deposit deposition in the reverse osmosis membrane in the basic design reverse osmosis membrane device 14 in the present example is predicted, the prediction is determined on the basis of a predetermined threshold value of the supply pressure or the supply flow rate for changing the supply condition of the detection liquid 15a and the change percentage of the permeated water for detection flow rate at the predetermined threshold value.

In addition, regarding the “predetermined threshold value” for this determination, in a case in which changes of the deposition conditions for deposits are “controlled using the supply pressure” of the detection liquid 15a, a “pressure value” that has been set in advance as a pressure at which deposits are deposited in the first reverse osmosis membrane for detection 21A is used as the “predetermined threshold value” (the detail thereof will be described below). In addition, in a case in which changes of the deposition conditions for deposits are controlled using, for example, the supply flow rate of the detection liquid 15a, a “flow rate value” that has been set as a flow rate at which deposits are deposited in the first reverse osmosis membrane for detection 21A is used as the “predetermined threshold value” (the detail thereof will be described below). Here, the supply pressure is controlled using a deposition condition altering device described below.

Here, the water to be treated 11 contains deposits or components generating deposits of ions of, for example, organic substances, microbes, mineral salts, and the like from, for example, mining wastewater, blow-down water from cooling towers in power generation plants, produced water during oil and gas extraction, brine water, and industrial wastewater. In addition, it is also possible to use seawater as the water to be treated 11 and apply the seawater to seawater conversion.

Examples of the separation membrane for separating dissolved components, for example, a saline matter from the water to be treated 11 include, in addition to reverse osmosis membranes (RO), nanofiltration membranes (NF) and forward osmosis membrane (FO).

Here, in a case in which the separation membrane is changed to a membrane other than the reverse osmosis membrane, it is possible to change the separation membrane for detection in the same manner and carry out detection.

The water to be treated 11 is pressurized to a predetermined pressure by handling the high-pressure pump 16 provided in the water to be treated supply line L₁ and an adjusting valve 44B for adjusting the flow rate provided in the non-permeated water discharge line L₁₁ from the reverse osmosis membrane device 14 and is introduced into the reverse osmosis membrane device 14 provided with the reverse osmosis membrane.

In addition, examples of the deposits deposited in the reverse osmosis membrane include inorganic deposits such as calcium carbonate, magnesium hydroxide, calcium sulfate, and silicate, natural organic substances and microbe-derived organic deposits, and colloidal components such as silica, and dispersed components containing an emulsion such as oil, but the deposits are not limited thereto as long as substances can be deposited in membranes.

In the reverse osmosis membrane device 14, the water to be treated 11 is desalinated by the reverse osmosis membrane in the reverse osmosis membrane device 14, thereby obtaining the permeated water 13. In addition, the non-permeated water 15 in which the dissolved components containing ions or organic substances are concentrated by the reverse osmosis membrane is appropriately disposed of or treated as waste or is used to collect valuables in the non-permeated water.

In the present example, the non-permeated water branch line L₁₂ for branching part of the non-permeated water from the non-permeated water line L₁₁ for discharging the non-permeated water 15 is provided.

In addition, the first deposit detecting unit 24A having the first reverse osmosis membrane for detection 21A for separating the detection liquid 15a that has branched off into the permeated water for detection 22 and the non-permeated water for detection 23 is installed in the non-permeated water branch line L₁₂.

The high-pressure pump 16a is provided on the front flow side of the first deposit detecting unit 24A in the non-permeated water branch line L₁₂, an adjusting valve 44A for adjusting the flow rate is provided in the non-permeated water for detection discharge line L₁₄ from the first deposit detecting unit 24A, and the flow rate of the permeated water for detection 22 from the first deposit detecting unit 24A is adjusted by handling the high-pressure pump 16a and the adjusting valve 44A. In addition, the supply pressure and the supply flow rate of the detection liquid 15a that has branched off are adjusted so that the desalination condition of the first deposit detecting unit 24A become identical to the desalination condition near the outlet of the reverse osmosis membrane in the basic design reverse osmosis membrane device 14. The predetermined pressure and flow rate are monitored using pressure meters 42A and 42B and flow instruments 43A and 43B.

Furthermore, the flow rate of the permeated water for detection 22 from the first deposit detecting unit 24A may be adjusted using any one of the adjusting valve 44A and the high-pressure pump 16a.

Meanwhile, a pressure meter 42C is provided in the non-permeated water for detection discharge line L₁₄ for discharging the non-permeated water for detection 23, and the adjusting valve 44B is provided in the non-permeated water line L₁₁ for the non-permeated water 15, respectively.

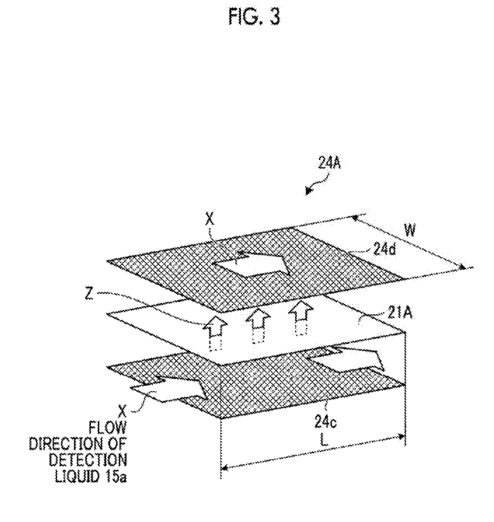

FIG. 3 is a perspective view of the first deposit detecting unit in FIG. 2.

As illustrated in FIGS. 2 and 3, the first deposit detecting unit 24A is a member for introducing the detection liquid 15a that has branched off from an inlet 24b side of a detecting unit main body 24a, and the first reverse osmosis membrane for detection 21A is sandwiched by a spacer (non-permeating side) 24c and a spacer (permeating side) 24d. In addition, the introduced detection liquid 15a flows along the first reverse osmosis membrane for detection 21A (X direction). In addition, this detection liquid 15a moves in a direction (Z direction) perpendicular to the detection liquid flow direction (X direction), passes through the first reverse osmosis membrane for detection 21A, and is desalinated, thereby obtaining the permeated water for detection 22. The permeated water for detection 22 that has been permeated forms the permeated water flow (X direction) which runs along the first reverse osmosis membrane for detection 21A and is discharged from a permeated water outlet 24e as the permeated water for detection 22. In FIG. 3, the length (L) of the detection liquid 15a in the flow direction (X direction) is the length of a flow channel in the first deposit detecting unit 24A, and the length of the first deposit detecting unit 24 in the depth direction in FIG. 2 reaches W.

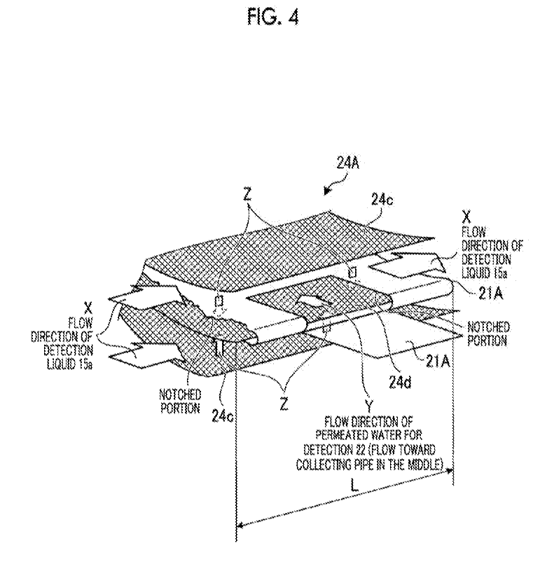

FIG. 4 is a partially-notched perspective view of a case in which a spiral reverse osmosis membrane is used in the first deposit detecting unit. As illustrated in FIG. 4, a spiral first reverse osmosis membrane for detection 21A is used as the membrane for detection in the first deposit detecting unit 24A, the detection liquid 15a is supplied from both surfaces of the first reverse osmosis membrane for detection 21A, the first reverse osmosis membrane for detection 21A is moved in a direction (Z direction) perpendicular to the flow direction of the detection liquid 15a, and the detection liquid passes through the membrane and is thus desalinated and turns into the permeated water for detection 22. In addition, since the spiral reverse osmosis membrane is used, the permeated water for detection 22 flows toward a collecting pipe in the center (in a Y direction). Meanwhile, in FIG. 4, a notched portion illustrates a state of the spiral reverse osmosis membrane 21 being cut open, and the spacer (permeating side) 24d inside the spiral reverse osmosis membrane is illustrated.

In this first deposit detecting unit 24A, for example, the resin spacer (non-permeating side) 24c is provided in order to ensure a flow channel forming a uniform flow (in the detection liquid flow direction (the X direction)) from the inlet 24b through a non-permeated water outlet 24f. In addition, on the permeated water side as well, similarly, for example, the resin spacer (permeating side) 24d is provided in order to ensure a flow channel forming a uniform flow (in the detection liquid flow direction (the X direction)) through the permeated water outlet 24e. Here, the member provided is not limited to spacers as long as the member is capable of ensuring a uniform flow.

In addition, the length (L) of the flow channel in the first deposit detecting unit 24A is preferably set to approximately 1/10 or shorter of the total length of the reverse osmosis membrane in the reverse osmosis membrane device 14, which is used in the basic design reverse osmosis membrane device 14, in the flow direction of the supply liquid, more preferably set to 1/50 or shorter of the length, and still more preferably set to 1/100 or shorter of the length. Meanwhile, in the first deposit detecting unit 24A used in test examples, flow channels having a length (L) of 16 mm or 1,000 mm were used.

Here, as described below, eight elements (having a length of, for example, 1 m) of the reverse osmosis membrane in the basic design reverse osmosis membrane device 14 are connected to each other and thus form one vessel. For example, in a case in which one vessel includes eight elements, when two vessels are connected to each other in series, the membrane length in the flow direction of the supply liquid in the reverse osmosis membrane device 14 reaches 16 m, and, in a case in which a reverse osmosis membrane having a flow channel length of 1,000 mm is used as a detection membrane, the length of the flow channel in the first deposit detecting unit 24A reaches 1/16 ( 1/10 or shorter).

Similarly, in a case in which a 16 mm-long reverse osmosis membrane is used as the detection membrane, the length of the flow channel in the first deposit detecting unit 24A reaches 0.016/16 ( 1/100 or shorter).

In addition, when the length W in the depth direction (the direction perpendicular to the flow of the supplied water) of the first reverse osmosis membrane for detection 21A which is the detection membrane in the first deposit detecting unit 24A is set to be constant, as the membrane length (L) decreases, the film area decreases. In addition, “when 10% of the membrane surface is clogged due to the deposition of deposits, the permeated water flow rate decreases by 10%”, and, as the membrane area decreases, the membrane is clogged early due to the deposition, and thus it becomes possible to rapidly detect a decrease of the permeated water flow rate with a high sensitivity.

Here, as the first reverse osmosis membrane for detection 21A in the first deposit detecting unit 24A, a separation membrane which exhibits a reverse osmosis action, is identical or similar to the reverse osmosis membrane in the basic design reverse osmosis membrane device 14, and exhibits a desalination performance is used.

In the present example, the reverse osmosis membrane in the basic design reverse osmosis membrane device 14 is a plurality of reverse osmosis membrane elements provided with a spiral reverse osmosis membrane stored in a pressure-resistant container.

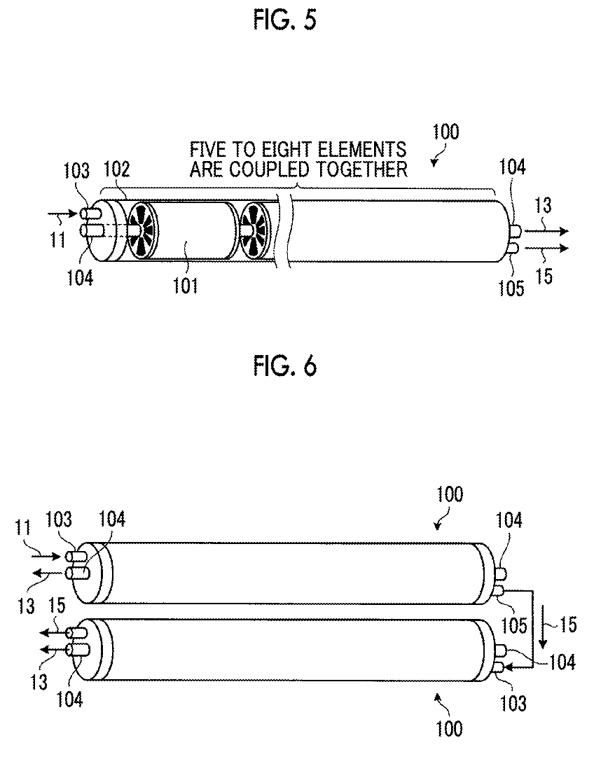

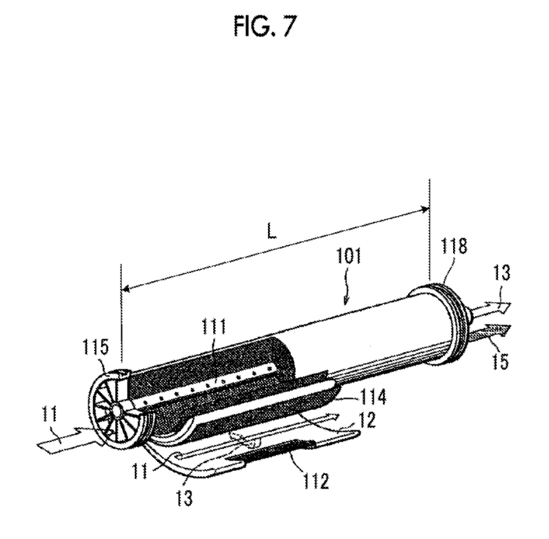

Here, an example of the spiral reverse osmosis membrane will be described. FIG. 5 is a partially-notched schematic view of a vessel in a spiral reverse osmosis membrane device. FIG. 6 is a perspective view of two vessel in FIG. 5 coupled together. FIG. 7 is a schematic partially exploded view of the spiral reverse osmosis membrane element. The spiral reverse osmosis membrane element illustrated in FIG. 7 is an example disclosed by JP2001-137672A and is not limited thereto. Hereinafter, a vessel 100 in the reverse osmosis membrane device will be referred to as a vessel 100, and a spiral reverse osmosis membrane element 101 will be referred to as an element 101.

As illustrated in FIG. 5, the vessel 100 is constituted by storing a plurality (for example, five to eight) of the elements 101 connected to each other in series in a cylindrical container main body (hereinafter, referred to as “container main body”) 102. The water to be treated 11 is introduced as raw water from a raw water supply opening 103 on one end side of the container main body 102, and the permeated water 13 and the non-permeated water 15 were ejected from a permeated water ejection opening 104 on the other end side and a non-permeated water ejection opening 105. Meanwhile, in FIG. 5, the permeated water ejection opening 104 on the water to be treated 11 introduction side is in a state of being clogged.

FIG. 6 illustrates a case in which two vessels 100 are connected to each other in series. For example, in a case in which the length of one element 101 is set to 1 m, when eight elements constitute one vessel, the total flow channel length (the total length in the flow direction of the supply liquid) reaches a length of 8×2=16 m.

Each of the elements 101 in the container main body 102 has a structure in which, for example, a sac-like reverse osmosis membrane 12 including a flow channel material 112 is wound around the periphery of a collecting pipe 111 as illustrated in FIG. 7 in a spiral shape using a flow channel material (for example, a mesh spacer) 114 and a brine seal 115 is provided in one end. In addition, each of the elements 101 sequentially guides the water to be treated (raw water) 11 having a predetermined pressure, which is supplied from the front brine seal 115 side between the sac-like reverse osmosis membranes 12 using the flow channel material (for example, a mesh spacer) 114 and ejects the permeated water 13 which has permeated the reverse osmosis membrane 12 due to the reverse osmosis action through the collecting pipe 111. In addition, the non-permeated water 15 is also ejected from a rear seal 118 side. Meanwhile, the membrane length in the movement direction of the water to be treated 11 is L. Here, the constitution of the element 101 illustrated in FIG. 7 is also identical even in the constitution of the spiral first deposit detecting unit 24A illustrated in FIG. 4.

A collection of a plurality (for example, 50 to 100) of the pressure-resistant containers is used as one unit, the number of units is adjusted depending on the supply amount of the water to be treated 11 being treated, and the water to be treated is desalinated, thereby manufacturing product water.

In the related art, at least part of the non-permeated water from the basic design reverse osmosis membrane device 14 is permeated through a separation membrane for monitoring, and the precipitation of deposits included in the non-permeated water on the membrane surface of the separation membrane for monitoring is monitored using a pressure difference between pressure meters provided before and after the separation membrane for monitoring. However, there is a problem in that, in a case in which the pressure difference is confirmed, it is not possible to determine the precipitation of deposits until a large amount of the deposits are precipitated and thus flow channels are clogged with the deposits and the pressure difference changes.

In addition, there is another problem in that, in a case in which the pressure difference is measured, as the length of the separation membrane for monitoring increases, it becomes more difficult to accurately detect the precipitation.

Generally, in the operation of the reverse osmosis membrane device, it is assumed that there are dissolved components or the like containing predetermined ions or organic substances in the water to be treated 11 and conditions under which deposits attributed to the dissolved components or the like containing ions or organic substances are not deposited in the reverse osmosis membrane is designed as the operation condition. However, there are cases in which, due to the water quality variation or the like of the water to be treated being supplied, the concentration of the dissolved components containing ions or organic substances becomes higher than the designed conditions, and a status in which deposits are easily deposited in the reverse osmosis membrane is formed. In this case, the permeated water flow rate of the permeated water 13 from the reverse osmosis membrane device 14 is confirmed using a flow instrument, and the reverse osmosis membrane is washed when the flow rate of the permeated water 13 decreases to a predetermined percentage, which is considered as a threshold value; however, at this time, deposits have already been deposited in a wide range of the reverse osmosis membrane, and it becomes difficult to wash the reverse osmosis membrane.

Therefore, in the present example, a deposit monitoring device for a desalination treatment device being provided with a non-permeated water line L₁₁ for discharging the non-permeated water 15 in which dissolved components containing ions or organic substances are concentrated from the reverse osmosis membrane device 14 in which the permeated water 13 has been filtrated from the water to be treated 11 by means of the reverse osmosis membrane, the first deposit detecting unit 24A provided in the non-permeated water branch line L₁₂ branched from the non-permeated water line L₁₁ and having the first reverse osmosis membrane for detection 21A in which the detection liquid 15a that has branched off is separated into the permeated water for detection 22 and the non-permeated water for detection 23, the deposition condition altering device for altering deposition conditions for deposits in the first reverse osmosis membranes for detection 21A, and the first flow rate measuring device for permeated water for detection 41A that measures the flow rate of the permeated water for detection 22 as illustrated in FIG. 1 is installed.

In addition, the degree of supersaturation of deposit components (for example, gypsum) in the membrane surface in the first reverse osmosis membrane for detection 21A is altered using the deposition condition altering device for altering the deposition conditions for deposits in the first reverse osmosis membrane for detection 21A. Here, the deposition condition altering device is not particularly limited as long as the device is capable of altering the conditions for the deposition of deposits in the first reverse osmosis membrane for detection 21A, and examples thereof include deposition condition altering devices for accelerating deposit deposition, deposition condition altering devices for decelerating deposit deposition, and the like. Hereinafter, a deposition condition altering device for accelerating deposit deposition will be exemplified.

The deposition condition altering device is a member for further altering the desalination conditions in the first deposit detecting unit 24A from the basic conditions of the first basic design reverse osmosis membrane device 14 and alters the deposition conditions by adjusting the pressure or flow rate of the detection liquid 15a which is part of the non-permeated water 15 being supplied.

For example, in a case in which the deposition conditions are altered by adjusting the pressure, the deposition condition altering device is a pressure adjusting device for altering the supply pressure of the detection liquid 15a that has branched off and, specifically, the adjusting valve 44A provided in the non-permeated water for detection discharge line L₁₄ for discharging the non-permeated water for detection 23 from the first deposit detecting unit 24A is handled. In addition, it is also possible to alter the pressure of the detection liquid 15a by handling the adjusting valve 44A and the high-pressure pump 16a.

Furthermore, in addition to adjusting the pressure using the adjusting valve 44A and the high-pressure pump 16a, it is also possible to, for example, provide an orifice or the like on the rear side of a branching unit of the non-permeated water branch line L₁₂ in the non-permeated water line L₁₁ for discharging the non-permeated water 15 and adjust the pressure of the detection liquid 15 that has branched off which is introduced into the non-permeated water branch line L₁₂ in the same manner.

In addition, the supply pressure of the detection liquid 15a is altered (for example, the supply pressure of the detection liquid 15a is increased by adjusting the adjusting valve 44A) without altering the concentration of the dissolved components containing ions in the detection liquid 15a that has branched off, and the permeated water amount of the permeated water for detection 22 in the first reverse osmosis membrane for detection 21A is measured, thereby determining the presence or absence of deposit deposition in the first reverse osmosis membrane for detection 21A.

The presence or absence of the deposition of deposit is determined on the basis of the measurement results of the flow rate of the first flow rate measuring device for permeated water for detection 41A provided in the permeated water for detection discharge line L₁₃ of the permeated water for detection 22.

In the present example, the supply pressure of the detection liquid 15a being supplied to the first reverse osmosis membrane for detection 21A in the first deposit detecting unit 24A is increased using the adjusting valve 44A so as to increase deposits being deposited in the first reverse osmosis membrane for detection 21A in an accelerating manner, whereby the flow rate of the detection liquid 15a is adjusted using the high-pressure pump 16a.

Next, the relationship between the supply pressure and the permeated water flow rate in a case in which the deposition conditions of scale components are altered by adjusting the pressure will be described.

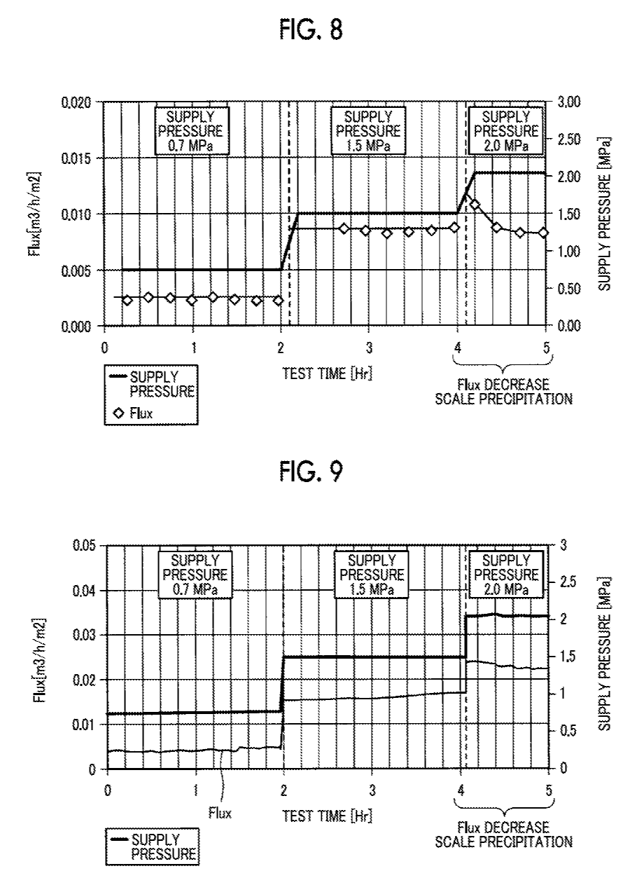

FIG. 8 is a view illustrating the behavior of a flux caused by a change of the supply pressure in a case in which the film length of the first reverse osmosis membrane for detection 21A is set to 16 mm under a condition in which the degree of supersaturation of gypsum in the supply liquid in the reverse osmosis membrane for detection is set to be constant at 4.7. In FIG. 8, the left vertical axis indicates the flux (m³/h/m²), the right vertical axis indicates the supply pressure (MPa), and the horizontal axis indicates the operation time (hours). In the present test example, gypsum was used as a deposit. Meanwhile, evaluation values are indicated as fluxes (the permeated water flow rate per unit membrane area) (m³/h/m²). Meanwhile, in the present test example, the degrees of supersaturation of gypsum in the detection liquid 15a which is the supply liquid and the non-permeated water for detection 23 were 4.7.

Here, in the first deposit detecting unit 24A, the degree of supersaturation of gypsum in the detection liquid 15a was set to be constant, and the presence or absence of the precipitation of gypsum was confirmed by changing only the supply pressure of the detection liquid 15a.

As illustrated in FIG. 8, in the case of the supply pressures of 0.7 MPa and 1.5 MPa, the flux does not change, and gypsum deposits are not generated. In contrast, in a case in which the supply pressure is increased up to 2.0 MPa, the flux decreased, and the generation of gypsum deposits was confirmed.

FIG. 9 is a view illustrating the behavior of the flux caused by a change of the supply pressure in a case in which the film length of the first reverse osmosis membrane for detection is set to 1,000 mm under the condition in which the degree of supersaturation of gypsum in the supply liquid in the first reverse osmosis membrane for detection is set to be constant.

As illustrated in FIG. 9, in the case of the supply pressures of 0.7 MPa and 1.5 MPa, the flux does not change, and gypsum deposits are not generated. In contrast, in a case in which the supply pressure is increased up to 2.0 MPa, the flux decreased, and the generation of gypsum deposits was confirmed.

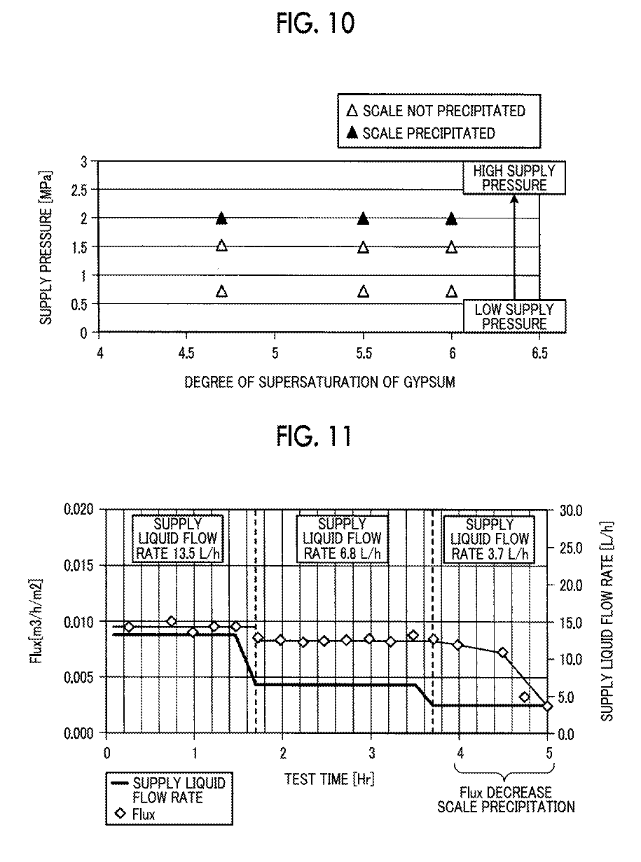

FIG. 10 is a view illustrating a relationship in a case in which only the supply pressure is changed for detection liquids having different degrees of supersaturation of gypsum.

In the test example illustrated in FIG. 8, the degree of supersaturation of gypsum in the detection liquid 15a was 4.7; however, as illustrated in FIG. 10, even in a case in which the degree of supersaturation of gypsum in the detection liquid 15a was 5.5 or 6.0, similarly, when the supply pressure increases, the precipitation of gypsum was confirmed.

Meanwhile, in the present test example as well, for both cases in which the degrees of supersaturation of gypsum in the detection liquid 15a were 5.5 and 6.0, the degrees of supersaturation of gypsum in the non-permeated water for detection 23 were 5.5 and 6.0 in the respective cases.

Here, the degree of supersaturation refers to the ratio of the concentration of gypsum in a case in which, for example, when gypsum is used as an example, a state in which gypsum is saturated and dissolved under a certain condition (the degree of supersaturation of gypsum) is set to “1”, and, for example, the degree of supersaturation of “5” indicates a concentration being five times higher than the degree of supersaturation of gypsum.

Next, a test for confirming whether or not the permeated water flow rate could be restored by washing the first reverse osmosis membrane for detection 21A was carried out.

Specifically, gypsum was forcibly precipitated in the first reverse osmosis membrane for detection 21A, the membrane was washed, and then whether or not the permeated water flow rate before the precipitation of gypsum could be restored was confirmed.

As the condition for the precipitation of gypsum which was a deposit, a condition in which the permeated water flow rate was decreased by 10% using the first flow rate measuring device for permeated water for detection 41A was set.

The operation conditions are shown in Table 1. Meanwhile, a NaCl evaluation liquid (NaCl: 2,000 mg/L) was used as the supply liquid.

TABLE 1

| | | Scale forcibly | | Desalination |
|---|---|---|---|---|
| Operation | Desalination (1) | precipitated | Washing | (2) |
| Pressure | 1.18 MPa | 2.0 MPa | | 1.18 MPa |
| condition | | | | |
| Amount of | 24 | Decreased | | 24 |
| permeated | | | | |
| water | | | | |
| (ml/h) | | | | |
| Supply | NaCl evaluation | Gypsum | Ion- | NaCl |
| liquid | liquid | supersaturated | exchange | evaluation |
| | | liquid | water | liquid |
| Deposit | Absent | Present | | Absent |

The operation was handled as described below.

1) First, the amount of the permeated water in a case in which the pressure condition was set to 1.18 MPa and a NaCl evaluation liquid was used as the supply liquid was 24 ml/h.

2) After that, the supply pressure condition was increased to 2.0 MPa, the supply liquid was changed from the NaCl evaluation liquid to a gypsum-supersaturated liquid, scale was forcibly precipitated in the membrane, and a decrease of the permeated water flow rate by 10% was confirmed.

3) After that, the supplied water was changed from the gypsum-supersaturated liquid to ion-exchange water, and washing was carried out.

4) After the washing, the supply liquid was changed from the ion-exchange water to the NaCl evaluation liquid, operation was carried out under the operation condition of 1) (the pressure condition was 1.18 MPa), and the amount of the permeated water was found to be 24 ml/h.

As a result, it was confirmed that, in the initial stage of the precipitation of gypsum in the first reverse osmosis membrane for detection 21A, gypsum deposits could be washed by means of water washing, and the permeated water flow rate was restored to that before the precipitation of the deposits by carrying out washing.

It was confirmed that, in a case in which gypsum was washed, gypsum could be washed using pure water. Therefore, in the washing of the basic design reverse osmosis membrane device 14 as well, washing using the permeated water 13 becomes possible. Therefore, it becomes possible to reduce costs and reduce the damage of membranes in washing steps.

FIG. 11 is a view illustrating the behavior of the flux caused by a change of the supply pressure in a case in which the film length of the reverse osmosis membrane for detection is set to 16 mm under the condition in which the degree of supersaturation of gypsum in the supply liquid in the reverse osmosis membrane for detection is set to be constant. In FIG. 11, the left vertical axis indicates the flux (m³/h/m²), the right vertical axis indicates the supply flow rate (L/h) of the detection liquid, and the horizontal axis indicates the operation time (hours).

As illustrated in FIG. 11, in the present test, it was confirmed that, in a case in which the flow rate of the supply liquid was 13.5 L/h or 6.8 L/h in a state in which the supply pressure of the detection liquid was fixed to 1.5 MPa, gypsum was not precipitated; however, when the flow rate of the supply liquid was as slow as 3.7 L/h, gypsum was precipitated. As a result, it was confirmed that, as the supply liquid flow rate of the detection liquid 15a (hereinafter, also referred to simply as “supply flow rate”) decreases, it becomes easier for gypsum to be precipitated.

Next, the prediction of deposit deposition in the reverse osmosis membrane in the reverse osmosis membrane device 14 using the first deposit detecting unit 24A will be described.

Generally, the basic design reverse osmosis membrane device 14 is operated according to design values; however, in a case in which there is no water quality variation in the water to be treated 11, the deposition of deposits in the reverse osmosis membrane in the reverse osmosis membrane device 14 is not observed for a predetermined time. However, in a case in which water quality variation occurs in the water to be treated 11, there are cases in which deposits are deposited in the reverse osmosis membrane in the reverse osmosis membrane device 14.

In the present example, the deposition of deposits in the reverse osmosis membrane in the basic design reverse osmosis membrane device 14 is predicted using the above-described water quality variation or the like.

In the present example, the tolerance until deposits begin to be deposited in the reverse osmosis membrane in the reverse osmosis membrane device 14 is determined from the detection results in the first deposit detecting unit 24A, the operation of the reverse osmosis membrane device 14 is optimally controlled on the basis of the tolerance, and the deposition of deposits in the reverse osmosis membrane is prevented.

In the first deposit detecting unit 24A, the non-permeated water 15 discharged from the reverse osmosis membrane device 14 is branched, and the pressure of the supply liquid is increased when this detection liquid 15a that has branched off is supplied, thereby accelerating deposit deposition in the first reverse osmosis membrane for detection 21A.

In addition, the deposit deposition tolerance is computed from the pressure increase percentage of the detection liquid 15a until deposits begin to be deposited in the first reverse osmosis membrane for detection 21A, and the operation of the basic design reverse osmosis membrane device 14 is controlled according to the tolerance, thereby preventing the deposition of deposits in the reverse osmosis membrane.

Furthermore, the deposit deposition tolerance is obtained from the pressure increase percentage of the detection liquid 15a until deposits begin to be deposited in the first reverse osmosis membrane for detection 21A, the operation of the reverse osmosis membrane device 14 is controlled using this deposit deposition tolerance, and the reverse osmosis membrane device is operated under the operation condition with a marginal tolerance at which deposits are not deposited, whereby the treatment efficiency of the basic design reverse osmosis membrane device 14 is improved or the treatment costs are reduced.

Deposit deposition in the first reverse osmosis membrane for detection 21A is indirectly detected from a decrease in the flow rate of the permeated water for detection 22 from the first deposit detecting unit 24A predicted using the first flow rate measuring device for permeated water for detection 41A.

Next, a determination step of the deposit deposition tolerance when the supply pressure of the detection liquid 15a is changed will be described.

1) First, when the water to be treated 11 is treated in the basic design reverse osmosis membrane device 14, the detection liquid 15a of part of the non-permeated water 15 discharged from the reverse osmosis membrane device 14 is supplied to the first deposit detecting unit 24A. At this time, the supply pressure and supply flow rate of the detection liquid 15a are adjusted so that the desalination condition of the first reverse osmosis membrane for detection 21A becomes identical to the desalination condition near the outlet of the non-permeated water 15 in the basic design reverse osmosis membrane device 14.

2) Next, the flow rate of the permeated water for detection 22 from the first deposit detecting unit 24A is measured using the first flow rate measuring device for permeated water for detection 41A.

3) In addition, the supply pressure of the detection liquid 15a is increased stepwise using the adjusting valve 44A until a decrease in the flow rate of the permeated water for detection 22 is measured.

4) The deposit deposition tolerance is obtained from the difference between the supply pressure of the detection liquid 15a when a decrease in the flow rate of the permeated water for detection 22 is measured and the supply pressure in the step 1).

In addition, the conditions are changed to an operation condition for washing the reverse osmosis membrane in the basic design reverse osmosis membrane device 14 on the basis of the result of the deposit detection tolerance. Alternatively, the conditions may be changed to an operation condition not allowing deposits to be deposited in the reverse osmosis membrane in the basic design reverse osmosis membrane device 14.

Next, an example of the control of the supply pressure of the detection liquid 15a for obtaining the deposit deposition tolerance will be described.

FIGS. 12-1 to 17 are views illustrating an example of controlling the supply pressure of the detection liquid in the present example. Meanwhile, in FIGS. 12-1 to 17, evaluation values (along the vertical axis) are expressed by the permeated water for detection flow rate, but values that can be arithmetically computed on the basis of the permeated water flow rate (for example, flux, a coefficient representing the permeation performance of a liquid in a membrane (A value), a standardized permeated water flow rate, or the like) can also be used.

FIGS. 12-1 to 14 illustrates a case in which the flow rate of the permeated water for detection 22 is confirmed by changing the supply pressure of the detection liquid 15a stepwise using one first deposit detecting unit 24A.

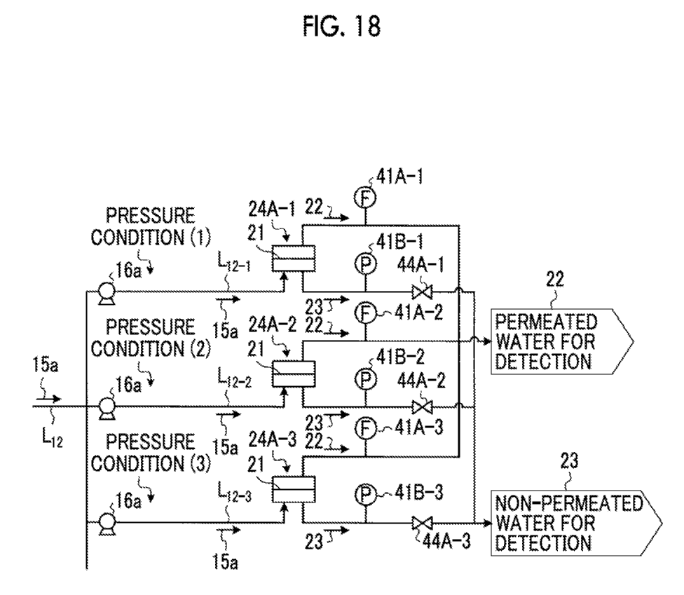

Meanwhile, FIGS. 15 to 17 illustrates a case in which the supply pressure of the detection liquid 15a is set to different pressures (pressure conditions (1) to (3)) respectively using three first deposit detecting units 24A-1, 24A-2, and 24A-3 as illustrated in FIG. 18 and the permeated water flow rate is confirmed.

FIG. 18 is a view illustrating an example in which three first deposit detecting units 24A-1, 24A-2, and 24A-3 are provided in three non-permeated water branch line L₁₂₋₁ to L₁₂₋₃.

In the desalination treatment device 10A illustrated in FIG. 1, the non-permeated water branch line L₁₂ is further branched into three non-permeated water branch lines L₁₂₋₁ to L₁₂₋₃, the first deposit detecting units 24A-1 to 24A-3 are respectively provided in the lines, and the flow rates of the permeated water for detection 22 are measured using the respective first flow rate measuring devices for permeated water for detection 41A-1 to 41A-3. Meanwhile, in the present example, the non-permeated water branch line L₁₂ is further branched into three lines, but it is also possible to provide three non-permeated water branch lines which directly branch from the non-permeated water line L₁₁ respectively and provide the first deposit detecting units 24A-1 to 24A-3 in each of the lines.

FIGS. 12-1 to 14 illustrate a case in which the supply pressure of the detection liquid 15a is slowly changed from the condition (1) to (3) and the change of the permeated water flow rate of the permeated water for detection 22 is confirmed using the first flow rate measuring device for permeated water for detection 41A.

Here, in the operation conditions of an ordinary operation (the operation conditions of the basic design reverse osmosis membrane device 14 at design values), it is confirmed in advance that the supply pressure condition of the detection liquid 15a under which deposits are deposited in the first reverse osmosis membrane 21A (the permeated water flow rate is decreased) becomes the condition (3).

In the present example, this supply pressure condition (the condition (3)) is set as the predetermined threshold value.

When the supply pressure of the detection liquid 15a becomes the condition (3), deposits are determined to be deposited in the first reverse osmosis membrane for detection 21A from a decrease in the flux.

That is, regarding the determination of the deposition of deposits, in a case in which the permeated water flow rate changes by a predetermined percentage in the predetermined time, deposits are determined to be deposited in the first reverse osmosis membrane for detection 21A. Therefore, in a case in which the permeated water flow rate changes by less than the predetermined percentage in the predetermined time, deposits are determined to be not deposited in the first reverse osmosis membrane for detection 21A, and, in a case in which the permeated water flow rate changes by the predetermined percentage or more in the predetermined time, deposits are determined to be deposited in the reverse first osmosis membrane for detection 21A.

Meanwhile, the conditions for determining the deposition of deposits (the predetermined time and the predetermined change percentage of the permeated water flow rate) are appropriately changed depending on the water quality, temperature, or the like of the water to be treated.

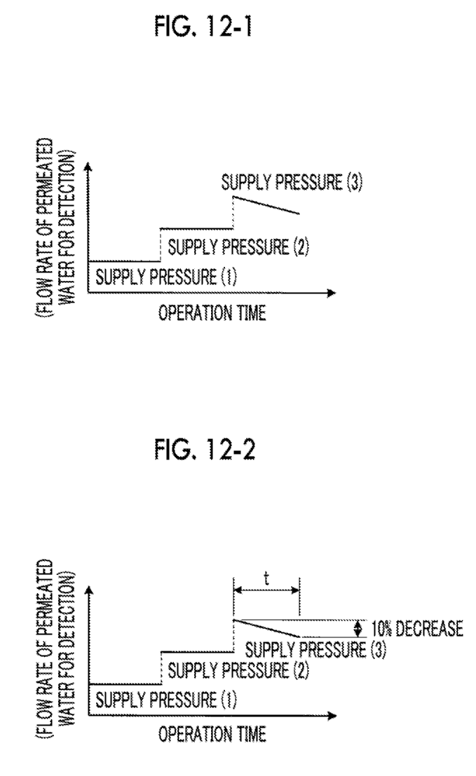

In addition, in a case in which the supply pressure of the detection liquid 15a being supplied to the first deposit detecting unit 24A is changed and consequently becomes as illustrated in FIG. 12-1, the tolerance is determined as, for example, “deposit deposition tolerance 2”, and the following control is carried out.

Here, the condition of the supply pressure (1) of the detection liquid 15a is, for example, 1.0 MPa, the condition of the supply pressure (2) of the detection liquid 15a is, for example, 1.5 MPa, and the condition of the supply pressure (3) of the detection liquid 15a is, for example, 2.0 MPa.

In the case illustrated in FIG. 12-2, for example, the predetermined threshold value is set to 2.0 MPa, and deposits are determined to be deposited when the permeated water flow rate changes by 10% or more as the predetermined percentage in ten minutes as the predetermined time (t). In a case in which the permeated water flow rate decreases by 10% or more, deposits are determined to be deposited in the first reverse osmosis membrane for detection 21A.

As a result of determining the tolerance as “deposit deposition tolerance 2” in FIG. 12-1, as the control in the control device 45, for example, any one of the following controls (1) to (3) is carried out.

Control (1): An operation for maintaining a status in which the operation conditions of the basic design reverse osmosis membrane device 14 do not change is carried out.

Control (2): The supply pressure as the operation condition for the basic design reverse osmosis membrane device 14 is increased.

Control (3): The amount of a deposit inhibitor 47 added to the water to be treated 11 from a deposit inhibitor supplying unit 46 illustrated in FIG. 1 is decreased.

Meanwhile, the determination of any one of these controls is carried out by an operator or is automatically carried out according to the previously-specified determination criteria.

Therefore, in the control (1), the operation does not change, and thus the production amount of the permeated water 13 does not change; however, in a case in which the operation load is increased by increasing the supply pressure as the operation condition of the basic design reverse osmosis membrane device 14 in the control (2), it is possible to increase the production amount of the permeated water 13.

In addition, when the amount of the deposit inhibitor 47 added is decreased as the control (3), it is possible to reduce medicine costs. This enables the prevention of the excess addition of the deposit inhibitor 47 to the basic design reverse osmosis membrane device 14.

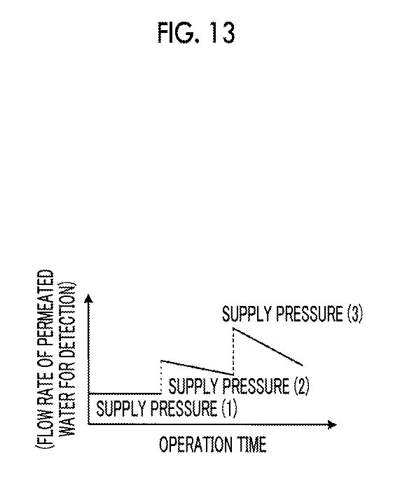

Next, in a case in which the supply pressure of the detection liquid 15a being supplied to the first deposit detecting unit 24A is changed and consequently becomes as illustrated in FIG. 13, the tolerance is determined as, for example, “deposit deposition tolerance 1”, and the following control is carried out.

Here, the condition of the supply pressure (1) of the detection liquid 15a is, for example, 1.0 MPa, the condition of the supply pressure (2) of the detection liquid 15a is, for example, 1.5 MPa, and the condition of the supply pressure (3) of the detection liquid 15a is, for example, 2.0 MPa.

Meanwhile, the supply pressure becoming as illustrated in FIG. 13 is considered to be attributed to the water quality variation or the like of the water to be treated 11 being supplied to the reverse osmosis membrane device 14.

As a result, the deposition tolerance is determined to be lower than that in the case of FIG. 12-1 described above.

As a result of determining the tolerance as “deposit deposition tolerance 1” in FIG. 13, as the control in the control device 45, for example, any one of the following controls (4) to (7) is carried out.

Control (4): The amount of the deposit inhibitor 47 added to the water to be treated 11 from the deposit inhibitor supplying unit 46 illustrated in FIG. 1 is increased.

Control (5): The reverse osmosis membrane in the reverse osmosis membrane device 14 is washed.

Control (6): The supply pressure of the water to be treated 11 in the reverse osmosis membrane device 14 is decreased.

Control (7): The supply amount of the water to be treated 11 is increased.

Meanwhile, the determination of any one of these controls is carried out by an operator or is automatically carried out according to the previously-specified determination criteria.

These controls enable an increase in the deposition tolerance of deposits in the reverse osmosis membrane in the basic design reverse osmosis membrane device 14. In addition, washing enables the prevention of deposits from being deposited in the reverse osmosis membrane in the basic design reverse osmosis membrane device 14 in advance.

In addition, as the washing method for washing in the control (5), it is possible to use, for example, flushing washing, sac bag washing, or the like. The washing method enables the extension of the service life of the reverse osmosis membrane in the basic design reverse osmosis membrane device 14. Meanwhile, in the washing, it is possible to use part of the permeated water 13.

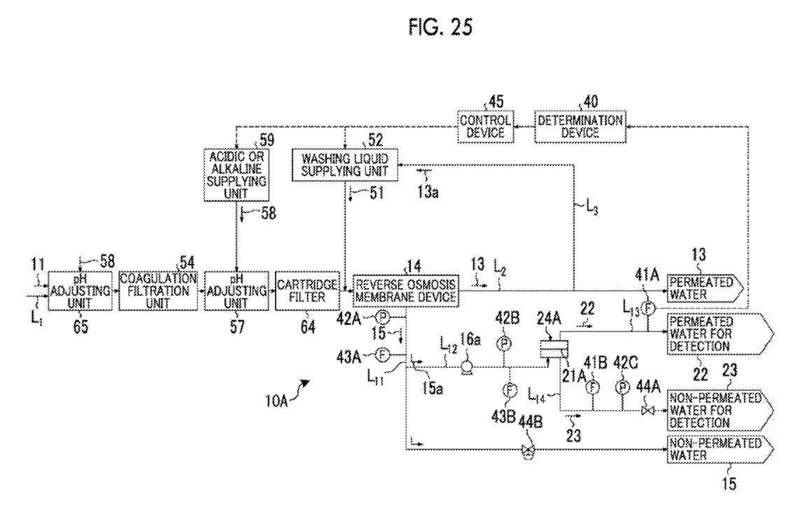

FIG. 25 is a schematic view illustrating an example of changing the operation conditions of the desalination treatment device according to Example 1.

As illustrated in FIG. 25, in a case in which washing is carried out as a result of the above-described determination, washing is carried out by supplying a supply liquid 51 from a washing liquid supplying unit 52. Here, as the washing liquid 51, it is possible to use part 13a of the permeated water 13. For example, it is also possible to send the part 13a of the produced permeated water 13 to the washing liquid supplying unit 52 from a permeated water supplying line L₃ branched from the permeated water discharge line L₂ and carry out a washing treatment by supplying the supply liquid 51. Therefore, it is possible to avoid washing using chemicals.

In addition, in the case of adjusting the pH of the water to be treated 11 being introduced into the reverse osmosis membrane device 14, an acidic or alkaline pH adjuster 58 being supplied to a pH adjusting unit 57 on the lower stream side of a coagulation filtration unit 54 is supplied from an acidic or alkaline supplying unit 59.

When the pH is adjusted to be alkaline, the precipitation of the scale components of, for example, silica, boron, or the like is prevented.

In addition, when the pH is adjusted to be acidic, the precipitation of the scale components of, for example, calcium carbonate or the like is prevented.

Furthermore, in a case in which the pH of the water to be treated 11 on the upper stream side of the coagulation filtration unit 54, the acidic or alkaline pH adjuster 58 is supplied to a pH adjusting unit 65. In the pH adjusting unit 65, for example, when the pH is adjusted to be alkaline, the scale components in the water to be treated 11 is precipitated as, for example, magnesium hydroxide, calcium carbonate, or the like, and solid and liquid are separated from each other using a solid-liquid separation unit (not illustrated), thereby preventing the precipitation of the scale component.

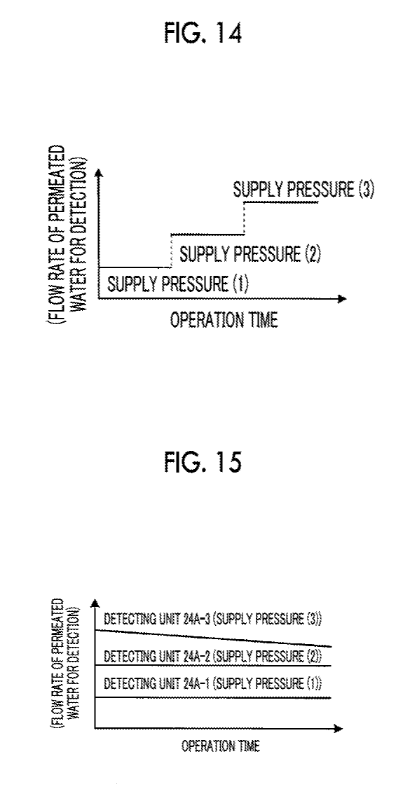

Next, in a case in which the supply pressure of the detection liquid 15a being supplied to the first deposit detecting unit 24A is changed and consequently becomes as illustrated in FIG. 14, the tolerance is determined as, for example, “deposit deposition tolerance 3 or 3 or higher”.

Here, the condition of the supply pressure (1) of the detection liquid 15a is, for example, 1.0 MPa, the condition of the supply pressure (2) of the detection liquid 15a is, for example, 1.5 MPa, and the condition of the supply pressure (3) of the detection liquid 15a is, for example, 2.0 MPa.

As a result, the deposition tolerance is determined to be higher than that in the case of FIG. 12-1 described above.

In this case, in the reverse osmosis membrane device 14, the concentration of the scale components in the water to be treated 11 is lower than the design condition, and it is possible to determine the state as a state in which it is more difficult for deposits to be deposited than in the case of FIG. 12-1.

As a result of determining the tolerance as “deposit deposition tolerance 3 or 3 or higher” in FIG. 14, the control in the control device 45 can be changed to an operation condition in which the deposition tolerance is decreased, and any one of the following controls (2) and (3) is carried out.

Control (2): The production amount of the permeated water 13 is increased by, for example, increasing the supply pressure as the operation condition for the basic design reverse osmosis membrane device 14.

Control (3): The amount of the deposit inhibitor 47 added to the water to be treated 11 from the deposit inhibitor supplying unit 46 illustrated in FIG. 1 is decreased.

Meanwhile, the determination of any one of these controls is carried out by an operator or is automatically carried out according to the previously-specified determination criteria.

Therefore, in a case in which the operation load is increased by increasing the supply pressure as the operation condition of the basic design reverse osmosis membrane device 14 as in the control (2), it is possible to increase the production amount of the permeated water 13.

In addition, when the amount of the deposit inhibitor 47 added is decreased as the control (3), it is possible to reduce medicine costs. This enables the prevention of the excess addition of the deposit inhibitor 47 to the basic design reverse osmosis membrane device 14.

As a result, it becomes possible to predict the prevention of the deposition of deposits in the membrane in the reverse osmosis membrane device 14 that treats the water to be treated 11 using the deposit monitoring device for a desalination treatment device.

As described above, in a case in which the deposition conditions for deposits in the first reverse osmosis membrane for detection 21A are changed using the deposition condition altering device when the permeated water for detection 22 separated by means of the first reverse osmosis membrane for detection 21A in the first deposit detecting unit 24A is measured, whether or not the flow rate of the permeated water for detection 22 changes more than the predetermined conditions (the change of the predetermined percentage of the flow rate in the predetermined time) at the predetermined threshold value is determined by measuring the flow rate using the first flow rate measuring device for separation water for detection 41A, and, as a result of the measurement, the tolerance for the operation condition of the basic design reverse osmosis membrane device 14 is determined.

In addition, the washing and operation conditions of the basic design reverse osmosis membrane device 14 are changed on the basis of the results of the tolerance determination.

Here, in the present example, since there are cases in which the flow rate of the permeated water for detection 22 is measured as the measurement of the flow rate of the separated liquid in the first reverse osmosis membrane for detection 21A, the presence or absence of the deposition in the first reverse osmosis membrane 21A is determined on the basis of whether or not the flow rate is decreased more than the predetermined condition.

In addition, it is possible to carry out the controls (1) to (7) as the operation condition of the basic design reverse osmosis membrane device 14 on the basis of the determination of the tolerance and prevent the deposition of deposits in the reverse osmosis membrane in the basic design reverse osmosis membrane device 14 in advance.

Here, in a case in which deposits are deposited in the first reverse osmosis membrane for detection 21A in the first deposit detecting unit 24A, it becomes possible to reuse the first reverse osmosis membrane for detection by washing the membrane. This is because, as shown in Table 1 of the above-described test example, in the initial stage of the precipitation of gypsum in the first reverse osmosis membrane for detection 21A, gypsum deposits can be washed by hand, and it becomes possible to remove the deposits by carrying out washing.

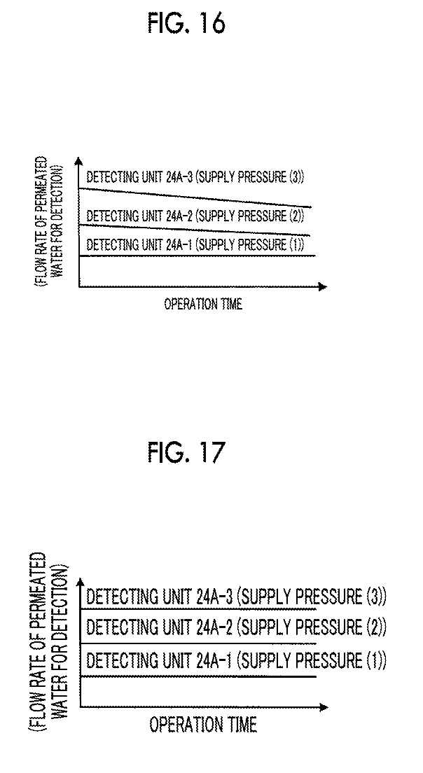

FIGS. 15 to 17 illustrates a case in which the supply pressure of the detection liquid 15a is set to different pressures respectively using the three first deposit detecting units 24A-1 to 24A-3 as illustrated in FIG. 18 and changes of the permeated water flow rate are confirmed, but determination and control are carried out in the same manner as in a case in which the permeated water flow rate is confirmed by changing the pressure stepwise using one first deposit detecting unit 24A, and thus the determination and the control will be not described again. Here, the setting in FIG. 15 corresponds to that in FIG. 12-1, the setting in FIG. 16 corresponds to that in FIG. 13, and the setting in FIG. 17 corresponds to that in FIG. 14.

Meanwhile, the first deposit detecting unit 24A-1 is the supply pressure (1) of the detection liquid 15a, the second deposit detecting unit 24A-2 is the supply pressure (2) of the detection liquid 15a, and the first deposit detecting unit 24A-3 is the supply pressure (3) of the detection liquid 15a.

Next, a determination step of the deposit deposition tolerance when the supply flow rate of the detection liquid 15a is changed will be described.

1) First, when the water to be treated 11 is treated in the basic design reverse osmosis membrane device 14, the detection liquid 15a of part of the non-permeated water 15 discharged from the reverse osmosis membrane device 14 is supplied to the first deposit detecting unit 24A. At this time, the supply pressure and supply flow rate of the detection liquid 15a are adjusted so that the desalination condition of the first reverse osmosis membrane for detection 21A becomes identical to the desalination condition near the outlet of the non-permeated water 15 in the basic design reverse osmosis membrane device 14.

2) Next, the flow rate of the permeated water for detection 22 from the first deposit detecting unit 24A is measured using the first flow rate measuring device for permeated water for detection 41A.

3) In addition, the supply flow rate of the detection liquid 15a is decreased stepwise using the high-pressure pump 16a until a decrease in the flow rate of the permeated water for detection 22 is measured.

4) The deposit deposition tolerance is obtained from the difference between the supply flow rate of the detection liquid 15a when the decrease in the flow rate of the permeated water for detection 22 is measured and the supply flow rate in the step 1).

In addition, the condition is changed to an operation condition for washing the reverse osmosis membrane in the basic design reverse osmosis membrane device 14 on the basis of the result of the deposit deposition tolerance. Alternatively, the condition may be changed to an operation condition not allowing deposits to be deposited in the reverse osmosis membrane in the basic design reverse osmosis membrane device 14.

Next, an example of the control of the supply flow rate of the detection liquid 15a for obtaining the deposit deposition tolerance will be described.

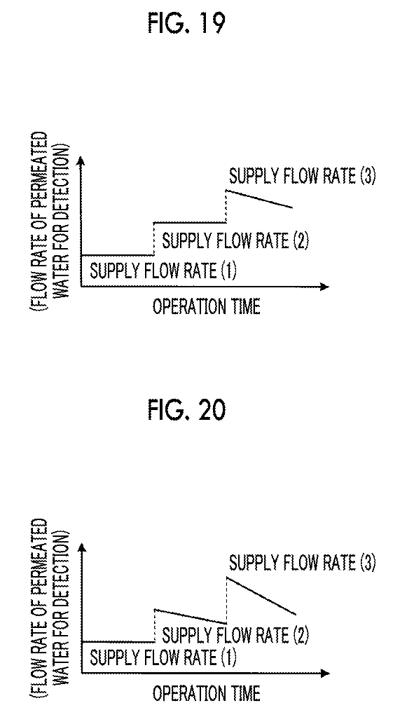

FIGS. 19 to 24 are views illustrating an example of controlling the supply flow rate of the detection liquid 15a in the present example.

FIGS. 19 to 21 illustrates a case in which a change of the permeated water for detection flow rate is confirmed by changing the supply flow rate of the detection liquid 15a stepwise using one first deposit detecting unit 24A.

FIGS. 22 to 24 illustrates a case in which the supply flow rate of the detection liquid 15a is set to different flow rates respectively using three first deposit detecting units 24A-1 to 24A-3 and the permeated water flow rate is confirmed.

In FIGS. 19 to 21, the supply flow rate of the detection liquid 15a is slowly changed from the condition (1) to (3) and the change of the permeated water flow rate is confirmed using the first flow rate measuring device for permeated water for detection 41A.

Here, in the operation conditions of an ordinary operation, it is confirmed in advance that the supply flow rate condition of the detection liquid 15a under which deposits are deposited (the permeated water flow rate is decreased) becomes the condition (3).

In the present example, this supply flow rate condition (the condition (3)) is set as the predetermined threshold value.

When the supply flow rate of the detection liquid 15a becomes the condition (3), deposits are determined to be deposited in the first reverse osmosis membrane for detection 21A from a decrease in the flux.

In addition, in a case in which the supply flow rate of the detection liquid 15a being supplied to the first deposit detecting unit 24A is changed and consequently becomes as illustrated in FIG. 19, the tolerance is determined as, for example, “deposit deposition tolerance 2”, and the following control is carried out.

Here, the condition of the supply flow rate (1) of the detection liquid 15a is, for example, 13.5 L/h, the condition of the supply flow rate (2) of the detection liquid 15a is, for example, 6.8 L/h, and the condition of the supply flow rate (3) of the detection liquid 15a is, for example, 3.7 L/h.

As a result of determining the tolerance as “deposit deposition tolerance 2” in FIG. 19, as the control in the control device 45, for example, any one of the following controls (1) to (3) is carried out.

Control (1): An operation for maintaining a status in which the operation conditions of the basic design reverse osmosis membrane device 14 do not change is carried out.

Control (2): The supply pressure as the operation condition for the basic design reverse osmosis membrane device 14 is increased.

Control (3): The amount of the deposit inhibitor 47 added to the water to be treated 11 from the deposit inhibitor supplying unit 46 illustrated in FIG. 1 is decreased.

Meanwhile, the determination of any one of these controls is carried out by an operator or is automatically carried out according to the previously-specified determination criteria.

Therefore, in the control (1), the operation does not change, and thus the production amount of the permeated water 13 does not change; however, in a case in which the operation load is increased by increasing the supply pressure as the operation condition of the basic design reverse osmosis membrane device 14 in the control (2), it is possible to increase the production amount of the permeated water 13.

In addition, when the amount of the deposit inhibitor 47 added is decreased as the control (3), it is possible to reduce medicine costs. This enables the prevention of the excess addition of the deposit inhibitor 47 to the basic design reverse osmosis membrane device 14.

Next, in a case in which the supply flow rate of the detection liquid 15a being supplied to the first deposit detecting unit 24A is changed and consequently becomes as illustrated in FIG. 20, the tolerance is determined as, for example, “deposit deposition tolerance 1”, and the following control is carried out.

Here, the condition of the supply flow rate (1) of the detection liquid 15a is, for example, 13.5 L/h, the condition of the supply flow rate (2) of the detection liquid 15a is, for example, 6.8 L/h, and the condition of the supply flow rate (3) of the detection liquid 15a is, for example, 3.7 L/h.

Meanwhile, the supply flow rate becoming as illustrated in FIG. 20 is considered to be attributed to the water quality variation or the like of the water to be treated 11 being supplied to the reverse osmosis membrane device 14.

As a result, the deposition tolerance is determined to be lower than that in the case of FIG. 19 described above.

As a result of determining the tolerance as “deposit deposition tolerance 1” in FIG. 20, as the control in the control device 45, for example, any one of the following controls (4) to (7) is carried out.

Control (4): The amount of the deposit inhibitor 47 added to the water to be treated 11 from the deposit inhibitor supplying unit 46 illustrated in FIG. 1 is increased.

Control (5): The reverse osmosis membrane in the reverse osmosis membrane device 14 is washed.

Control (6): The supply pressure of the water to be treated 11 in the reverse osmosis membrane device 14 is decreased.

Control (7): The supply amount of the water to be treated 11 is increased.

Meanwhile, the determination of any one of these controls is carried out by an operator or is automatically carried out according to the previously-specified determination criteria.

These controls enable an increase in the deposition tolerance of deposits in the reverse osmosis membrane in the basic design reverse osmosis membrane device 14. In addition, washing enables the prevention of deposits from being deposited in the reverse osmosis membrane in the basic design reverse osmosis membrane device 14 in advance.

In addition, as the washing method for washing in the control (5), it is possible to use, for example, blush washing, sac bag washing, or the like. The washing method enables the extension of the service life of the reverse osmosis membrane in the basic design reverse osmosis membrane device 14. Meanwhile, in the washing, it is possible to use part of the permeated water 13.

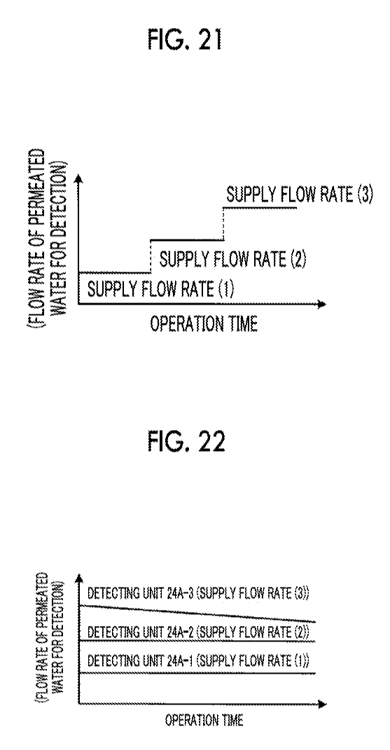

Next, in a case in which the supply flow rate of the detection liquid 15a being supplied to the first deposit detecting unit 24A is changed and consequently becomes as illustrated in FIG. 21, the tolerance is determined as, for example, the “deposit deposition tolerance 3 or 3 or higher”.

Here, the condition of the supply flow rate (1) of the detection liquid 15a is, for example, 13.5 L/h, the condition of the supply flow rate (2) of the detection liquid 15a is, for example, 6.8 L/h, and the condition of the supply flow rate (3) of the detection liquid 15a is, for example, 3.7 L/h.

As a result, the deposition tolerance is determined to be higher than that in the case of FIG. 19 described above.

As a result of determining the tolerance as “deposit deposition tolerance 3 or 3 or higher” in FIG. 21, the control in the control device 45 can be changed to an operation condition in which the deposition tolerance is decreased, and any one of the following controls (2) and (3) is carried out.

Control (2): The production amount of the permeated water 13 is increased by, for example, increasing the supply pressure as the operation condition for the basic design reverse osmosis membrane device 14.

Control (3): The amount of the deposit inhibitor 47 added to the water to be treated 11 from the deposit inhibitor supplying unit 46 illustrated in FIG. 1 is decreased.

Meanwhile, the determination of any one of these controls is carried out by an operator or is automatically carried out according to the previously-specified determination criteria.

Therefore, in a case in which the operation load is increased by increasing the supply pressure as the operation condition of the basic design reverse osmosis membrane device 14 as in the control (2), it is possible to increase the production amount of the permeated water 13.

In addition, when the amount of the deposit inhibitor 47 added is decreased as the control (3), it is possible to reduce medicine costs. This enables the prevention of the excess addition of the deposit inhibitor 47 to the basic design reverse osmosis membrane device 14.

As a result, it becomes possible to predict the prevention of the deposition of deposits in the membrane in the reverse osmosis membrane device 14 that treats the water to be treated 11 using the first deposit detecting unit 24A in the desalination treatment device.

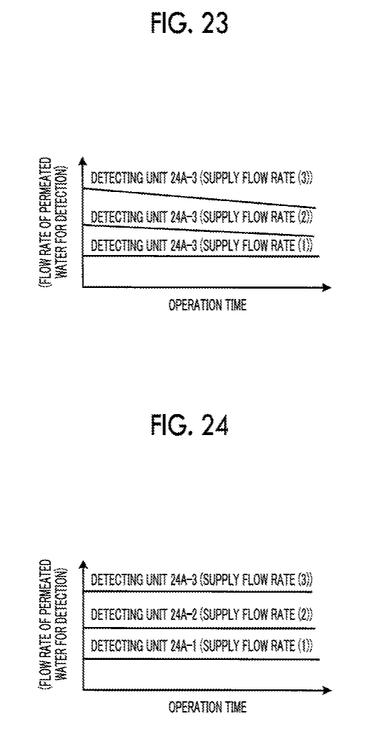

FIGS. 22 to 24 illustrates a case in which the supply flow rate of the detection liquid 15a is set to different flow rates respectively using the three first deposit detecting units 24A-1 to 24A-3 as illustrated in FIG. 18 and changes of the permeated water flow rate are confirmed, but determination and control are carried out in the same manner as in a case in which the permeated water flow rate is confirmed by changing the flow rate stepwise using one first deposit detecting unit 24A, and thus the determination and the control will be not described again. Here, the setting in FIG. 22 corresponds to that in FIG. 19, the setting in FIG. 23 corresponds to that in FIG. 20, and the setting in FIG. 24 corresponds to that in FIG. 21.

Meanwhile, the first deposit detecting unit 24A-1 is the supply flow rate (1) of the detection liquid 15a, the second deposit detecting unit 24A-2 is the supply flow rate (2) of the detection liquid 15a, and the first deposit detecting unit 24A-3 is the supply flow rate (3) of the detection liquid 15a.

In the present example, the deposition of deposits is predicted by accelerating deposit deposition in the first reverse osmosis membrane for detection 21A using the deposition condition altering device, but it is also possible to, without operating the deposition condition altering device, adjust the supply pressure and the supply flow rate so that the desalination condition of the first deposit detecting unit 24A becomes identical to the desalination condition near the outlet of the reverse osmosis membrane in the basic design reverse osmosis membrane device 14, measure the separated liquid from the first deposit detecting unit 24A using the flow rate measuring devices for separation water (the first flow rate measuring device for permeated water for detection 41A and the first flow rate measuring device for non-permeated water for detection 41B), and, in a case in which the measured flow rate is found to change with respect to the predetermined threshold value as a result of the measurement, determine the initiation of deposit deposition in the reverse osmosis membrane in the basic design reverse osmosis membrane device 14 using the determination device 40.

Specifically, the supply pressure and the supply flow rate of the detection liquid 15a are adjusted using one or both of the adjusting valve 44A and the high-pressure pump 16a so that the desalination condition of the first deposit detecting unit 24A becomes identical to the desalination condition near the outlet of the reverse osmosis membrane in the basic design reverse osmosis membrane device 14, whereby the same desalination condition as the desalination condition near the terminal of the outlet of the reverse osmosis membrane in the basic design reverse osmosis membrane device 14 is reproduced in the first reverse osmosis membrane for detection 21A.

A status in which the deposition state of deposits is detected using the first reverse osmosis membrane for detection 21A in the first deposit detecting unit 24A simulates a state of the final bristle (in a case in which eight spiral reverse osmosis membrane elements 101 are coupled together in series, the final tail portion (L) of the eighth element 101-8 of the elements 101-1 to 101-8) in the basic design reverse osmosis membrane device 14 and simulates a status of the deposition of deposit components (for example, gypsum) in the first reverse osmosis membrane for detection 21A. In a case in which the membrane length L of the first reverse osmosis membrane for detection 21A in the first deposit detecting unit 24A is set to, for example, 16 mm, it becomes possible to simulate a state of the final tail portion being 16 mm.

In the above description, a case in which the flow rate of the permeated water for detection 22 is measured using the first flow rate measuring device for permeated water for detection 41A has been described; however, in a case in which the flow rate of the non-permeated water for detection 23 is measured using the first flow rate measuring device for non-permeated water for detection 41B, when deposits are deposited, the flow rate of the non-permeated water for detection 23 increases, and thus the deposition conditions for deposits in the first reverse osmosis membrane 21A are changed, and, in a case in which the flow rate of the non-permeated water for detection 23 changes more than the predetermined amount (the change (increase) percentage of the non-permeated water flow rate for determining the deposition of deposits in the first reverse osmosis membrane for detection 21A), the “prediction of the deposition of” deposits in the reverse osmosis membrane is determined.

Therefore, it is possible to predict the occurrence of the deposition in the reverse osmosis membrane in the basic design reverse osmosis membrane device 14 from the water quality variation or the like of the water to be treated 11.

As a result of this prediction, it is possible to continue stable operation without causing the deposition of deposits in the reverse osmosis membrane in the basic design reverse osmosis membrane device 14 by changing the operation conditions of the basic design reverse osmosis membrane device 14.

In the above-described example, in a case in which the supply pressure of the supply liquid and the supply liquid flow rate are set to be constant, when deposits are deposited in the reverse osmosis membrane, since the permeated water flow rate (or flux) decreases, the supply pressure of the detection liquid and the supply flow rate of the supply liquid are set to the predetermined values, and, in a case in which the permeated water for detection flow rate (or flux) becomes equal to or less than the threshold value, deposits are determined to be deposited in the reverse osmosis membrane for detection.

In contrast, in a case in which the permeated water flow rate (or flux) is set to be constant, when deposits are deposited in the reverse osmosis membrane, it is necessary to increase the supply pressure of the supply liquid (increase the flux).

Therefore, in a case in which the supply pressure of the supply liquid is controlled so that the flow rate of the separated liquid for detection (permeated water for detection or non-permeated water for detection) becomes constant and the supply pressure becomes equal to or higher than the threshold value, deposits can also be determined to be deposited in the reverse osmosis membrane for detection.

### Example 2

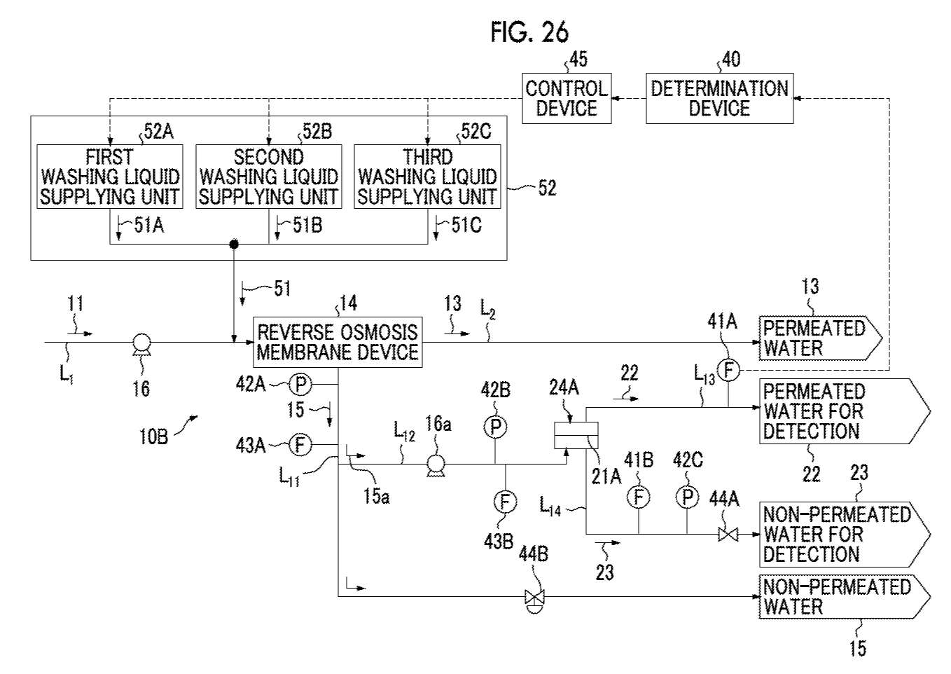

FIG. 26 is a schematic view of a desalination treatment device according to Example 2. As illustrated in FIG. 26, a desalination treatment device 10B according to the present example is a device in which deposit components deposited in the first reverse osmosis membrane for detection 21A in the first deposit detecting unit 24A are analyzed and washing is carried out on the deposits.

That is, when the basic design reverse osmosis membrane device 14 is operated in an ordinary operation, deposits are deposited in the first reverse osmosis membrane for detection 21A by changing the pressure (the flow rate) with respect to the first deposit detecting unit 24A in advance, and these deposited deposits are separately analyzed.

In addition, as a result of the analysis, out of previously-selected, for example, three types of washing liquid 51 (the first to third washing liquid 51A to 51C), the optimal washing liquid is selected, and washing is carried out using the optical washing liquid from the first to third washing liquid supplying units 52 (52A to 52C) as the washing liquid in the basic design reverse osmosis membrane device 14.

A variety of the washing liquids 51 are respectively supplied to the first reverse osmosis membrane for detection 21A in which the deposits have been deposited, and the permeated water for detection flow rate in the first reverse osmosis membrane for detection 21A is measured using the first flow rate measuring device for permeated water for detection 41A, thereby confirming the washing effect on the deposits in the first reverse osmosis membrane for detection 21A.

When the permeated water for detection flow rate is measured, it is possible to select the most effective washing conditions (washing liquid, temperature, and the like) for the deposits in the first reverse osmosis membrane for detection 21A. This selection result can be set as the washing condition for the reverse osmosis membrane in the basic design reverse osmosis membrane device 14.

In the related art, even when washing conditions (washing liquid and washing order) recommended for deposits have been specified, it is difficult to specify deposits in actual reverse osmosis membranes, deposits are assumed on the basis of prediction from the water quality of the water to be treated 11, and a washing liquid is selected, and thus there are cases in which appropriate washing is not possible.

In contrast, according to the present example, before deposits are deposited in the first reverse osmosis membrane for detection 21A in the basic design reverse osmosis membrane device 14, it becomes possible to evaluate the washing performances of a variety of washing liquids on actual deposits in advance. When these evaluation results are reflected for the reverse osmosis membrane in the basic design reverse osmosis membrane device 14, it becomes possible to carry out appropriate washing.

As a result, it becomes possible to easily select the most effective washing liquid 51 with respect to deposits that are actually predicted to be deposited in the reverse osmosis membrane in the basic design reverse osmosis membrane device 14.

In addition, the effective washing of the reverse osmosis membrane in the basic design reverse osmosis membrane device 14 becomes possible, and it is possible to shorten the washing time and reduce the amount of the washing liquid 51 used.

Here, deposits, for example, calcium carbonate, magnesium hydroxide, iron hydroxide, and the like can be washed using an acidic aqueous solution in which hydrochloric acid or the like is used as a washing liquid. In addition, silica, organic substances, and the like can be washed using an alkaline washing liquid in which sodium hydroxide or the like is used.

### Example 3

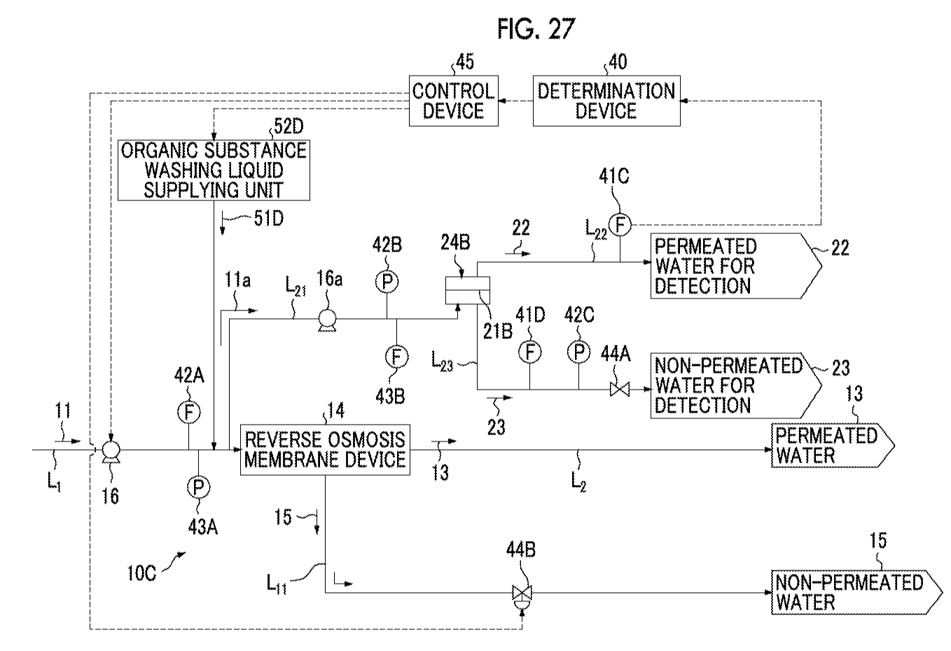

FIG. 27 is a schematic view of a desalination treatment device according to Example 3. Meanwhile, the same members as those in Example 1 will be given the same reference signs and will not be described again.

In the case of the desalination treatment device 10A of Example 1, the deposition of deposits attributed to the scale components in the non-permeated water 15 is predicted using the non-permeated water 15 from the reverse osmosis membrane device 14; however, in the present example, as illustrated in FIG. 27, the initial deposition stage of biofouling caused by deposits attributed to organic components or microbes in the water to be treated 11 is predicted on the introduction (supply) side of the water to be treated 11 being supplied to the reverse osmosis membrane device 14. Meanwhile, the constitution of a second deposit detecting unit 24B in the present example is identical to the constitution of the first deposit detecting unit 24A in Example 1 and thus will not be described again.

As illustrated in FIG. 27, a desalination treatment device 10C according to the present example is provided with the reverse osmosis membrane device 14 which has a reverse osmosis membrane for concentrating dissolved components containing ions or organic substances from the water to be treated 11 and obtaining the permeated water 13, a second deposit detecting unit 24B provided in a water to be treated branch line L₂₁ branched from a water to be treated introduction line L₁ for supplying the water to be treated 11, using part of the water to be treated 11 that has branched off as the detection liquid 11a, and having a second reverse osmosis membrane for detection 21B in which the detection liquid 11a is separated into the permeated water for detection 22 and the non-permeated water for detection 23, a deposition condition altering device for altering deposition conditions for deposits in the second reverse osmosis membrane for detection 21B, second flow rate measuring devices for separated liquid for detection (a second flow rate measuring device for permeated water for detection 41C and a second flow rate measuring device for non-permeated water for detection 41D) that measure the flow rates of the separated liquid (the permeated water for detection 22 and the non-permeated water for detection 23) separated by the second reverse osmosis membrane for detection 21B, and the control device 45 for carrying out one or both of execution of a washing treatment on the reverse osmosis membrane in the reverse osmosis membrane device 14 and a change to operation conditions (for example, operation conditions such as the pressure, the flow rate, and the concentration of the deposit inhibitor) not allowing deposits to be deposited in the reverse osmosis membrane device 14 as a result of measurement of the second flow rate measuring devices for separated liquid for detection (the second flow rate measuring device for permeated water for detection 41C and the second flow rate measuring device for non-permeated water for detection 41D). In the present example, the second flow rate measuring device for permeated water for detection 41C that measures the flow rate of the permeated water for detection 22 is provided in the permeated water for detection discharge line L₂₂, and the second flow rate measuring device for non-permeated water for detection 41D that measures the flow rate of the non-permeated water for detection 23 is provided in the non-permeated water for detection discharge line L₂₃.

In the present invention, the determination device 40 for determining that deposit deposition in the reverse osmosis membrane in the basic design reverse osmosis membrane device 14 is predicted as a result of measurement of the second flow rate measuring devices for separated liquid for detection (the second flow rate measuring device for permeated water for detection 41C and the second flow rate measuring device for non-permeated water for detection 41D) is installed, and, when the deposition of deposits in the reverse osmosis membrane in the basic design reverse osmosis membrane device is predicted by the determination in the determination device 40, one or both of execution of a washing treatment on the reverse osmosis membrane in the reverse osmosis membrane device 14 and a change to operation conditions (for example, operation conditions such as the pressure, the flow rate, and the concentration of a deposit inhibitor) not allowing deposits to be deposited in the reverse osmosis membrane device 14 are carried out using the control device 45, but the determination device 40 may be installed as necessary.

Biofouling caused by the deposition of organic components or microbes occurs on the supply side of the water to be treated 11 of the reverse osmosis membrane in the reverse osmosis membrane device 14.

Therefore, the second deposit detecting unit 24B having the second reverse osmosis membrane for detection 21B is provided in the water to be treated branch line L₂₁ branched from the water to be treated introduction line L₁, and, similar to Example 1, the deposition conditions are accelerated, whereby it is possible to predict the deposition of deposits in the head portion of the membrane elements in the reverse osmosis membrane device 14.

Here, regarding the determination condition for determining that deposit deposition in the reverse osmosis membrane in the basic design reverse osmosis membrane device 14 in the present example is predicted, the prediction is determined on the basis of, similar to Example 1, a predetermined threshold value of the supply pressure or the supply flow rate for changing the supply condition of the detection liquid 11a and the change percentage of the permeated water for detection flow rate at the predetermined threshold value.

In addition, regarding the “predetermined threshold value” for this determination, in a case in which changes of the deposition conditions for deposits are “controlled using the supply pressure” of the detection liquid 11a, a “pressure value” that has been set in advance as a pressure at which deposits are deposited in the second reverse osmosis membrane for detection 21B is used as the “predetermined threshold value”. In addition, in a case in which changes of the deposition conditions for deposits are controlled using, for example, the supply flow rate of the detection liquid 11a, a “flow rate value” that has been set as a flow rate at which deposits are deposited in the second reverse osmosis membrane for detection 21B is used as the “predetermined threshold value” (the detail thereof will be described below). Here, the supply pressure is controlled using the deposition condition altering device.

Meanwhile, the second reverse osmosis membrane for detection 21B may be a membrane of a material which is identical to or different from that of the first reverse osmosis membrane for detection 21A in Example 1.

In addition, the permeated water flow rate of the permeated water for detection 22 is measured using the second deposit detecting unit 24B in the present example, and a decrease in the permeated water flow rate is detected using the second flow rate measuring device for permeated water for detection 41C, whereby it is possible to predict the initial stage of biofouling caused by the deposition of organic components or microbes in the reverse osmosis membrane in the basic design reverse osmosis membrane device 14.

In addition, in a case in which the deposition of deposits in the reverse osmosis membrane in the reverse osmosis membrane device 14 is determined to be predicted in a case in which the permeated water flow rate of the permeated water for detection 22 from the second deposit detecting unit 24B is detected using the second flow rate measuring device for permeated water for detection 41C and the measured flow rate changes from a predetermined threshold value by equal to or less than a predetermined amount, one or both of execution of a washing treatment on the reverse osmosis membrane in the reverse osmosis membrane device 14 and a change to operation conditions not allowing deposits to be deposited in the desalination treatment device are carried out, whereby it is possible to prevent the biofouling caused by deposition of organic components or microbes in the basic design reverse osmosis membrane device 14.

In addition, in a case in which the non-permeated water flow rate of the non-permeated water for detection 23 from the second deposit detecting unit 24B is detected using the second flow rate measuring device for non-permeated water 41D and the measured flow rate changes from a predetermined threshold value by equal to or more than a predetermined amount, the deposition in the reverse osmosis membrane in the basic design reverse osmosis membrane device 14 is determined to be predicted, one or both of execution of a washing treatment on the reverse osmosis membrane in the reverse osmosis membrane device 14 and a change to operation conditions not allowing deposits to be deposited in the desalination treatment device are carried out, whereby it is possible to prevent the biofouling caused by deposition of organic components or microbes in the basic design reverse osmosis membrane device 14.

Here, with respect to biofouling caused by deposits attributed to organic components or microbes, washing becomes possible when, for example, a washing liquid obtained by adding a surfactant to an aqueous solution of sodium hydroxide is used.

Together with this washing work, furthermore, the operation condition may be changed to an operation condition not allowing deposits to be deposited in the reverse osmosis membrane in the basic design reverse osmosis membrane device 14. Meanwhile, this work and washing may be carried out at the same time or may be sequentially carried out.

1) An operation for decreasing the amount of a bactericidal agent (a chlorine-based bactericidal agent (for example, chloramine) or a medicine having an oxidation performance such as hydrogen peroxide) added is carried out.

2) An operation for increasing the amount of an agglomerating agent for organic substances added is carried out.

3) A flow channel is changed so as to run through to an organic adsorption tower (sand filtration, an activated coal adsorption tower, dissolved air flotation (DAF), a sterilization filter, or the like).

4) An operation for increasing the pH of the water to be treated 11 being supplied to the reverse osmosis membrane device 14 is carried out.

5) An operation for adding a washing liquid for organic substances is carried out.

When the operation condition is changed to the above-described operation condition not allowing the deposition of deposit, it is possible to carry out a stable desalination treatment.

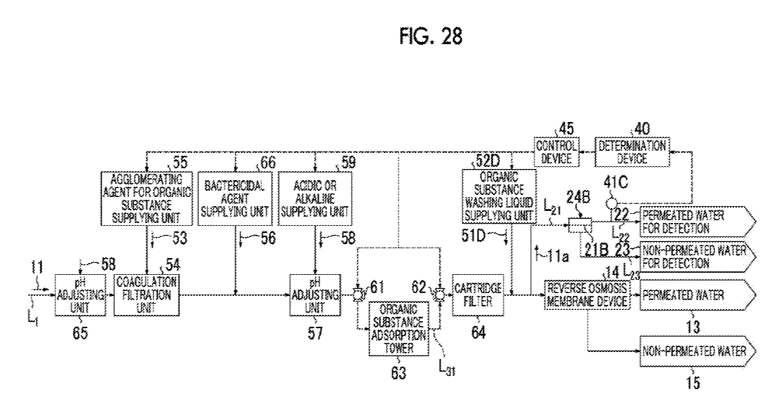

FIG. 28 is a schematic view illustrating an example of changing the operation conditions of the desalination treatment device according to Example 3.

In FIG. 28, when the permeated water flow rate of the permeated water for detection 22 from the second deposit detecting unit 24B is detected using the second flow rate measuring device for permeated water for detection 41C and a decrease of the permeated water flow rate is detected, it is determined by the determination device 40 that deposition occurs in the membrane. As a result of this determination, in a case in which washing is carried out, washing is carried out by supplying a washing liquid for organic substances 51D from an organic substance washing liquid supplying unit 52D.

In addition, in a case in which the amount of an agglomerating agent for organic substances 53 added to the water to be treated 11 is adjusted, the agglomerating agent for organic substances 53 is supplied from the agglomerating agent for organic substances supplying unit to the coagulation filtration unit 54, and organic substances are removed by the supply of the agglomerating agent for organic substances 53.

In addition, in a case in which the amount of a bactericidal agent 56 added to the water to be treated 11 is adjusted, the bactericidal agent 56 is supplied from a bactericidal agent supplying unit 57 on the lower stream side of the coagulation filtration unit 54. The amount of the bactericidal agent 56 added is decreased, thereby decreasing organic substances derived from microbes.

In addition, in a case in which the pH of the water to be treated 11 being introduced into the reverse osmosis membrane device 14 is adjusted, the acidic or alkaline pH adjuster 58 being supplied to the pH adjusting unit 57 on the lower stream side of the coagulation filtration unit 54 is supplied from the acidic or alkaline supplying unit 59, and the pH is adjusted, thereby annihilating microbes. In addition, when the pH is increased, the dissolution and deposition of organic substances is prevented.

In addition, in a case in which organic substances in the water to be treated 11 is further removed, switching units 61 and 62 for branching the flow channel from the water to be treated introduction line L₁ are handled on the lower stream side of the pH adjusting unit 57, the water to be treated 11 is passed through to an organic substance adsorption tower 63 interposed in a bypass channel L₃₁, and organic substances in the water to be treated 11 is adsorbed and removed.

In addition, a cartridge filter 64 is installed on the upper stream side of the reverse osmosis membrane device 14, and impurities in the water to be treated 11 are further filtered.

When the operation conditions are changed as described above, biofouling derived from microbes can be prevented. Meanwhile, in FIG. 28, the reference sign 65 indicates the pH adjusting unit and adjusts the pH of the water to be treated 11 which is raw water using the (acidic or alkaline) pH adjuster 58.

### Example 4

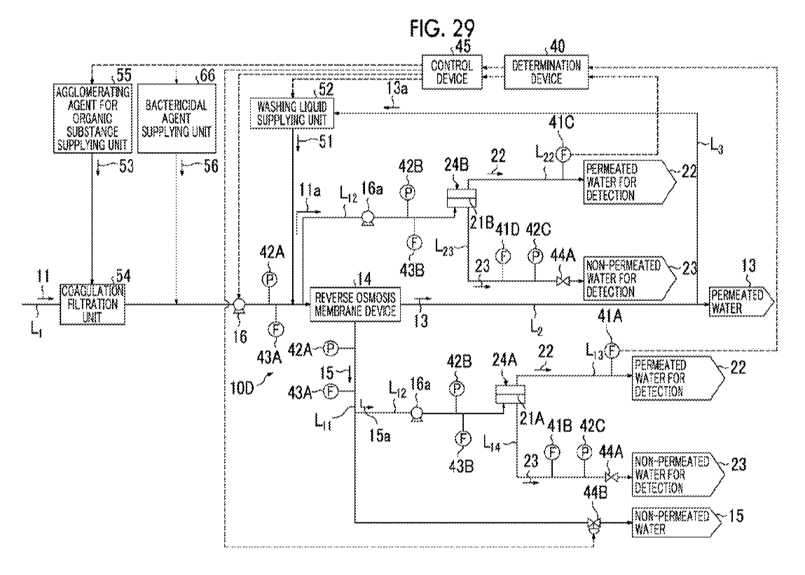

FIG. 29 is a schematic view of a desalination treatment device according to Example 4. Meanwhile, the same members as those in Examples 1, 2, and 3 will be given the same reference signs and will not be described again.

In the present example, as illustrated in FIG. 29, a desalination treatment device 10D of the present example is a device that predicts the deposition of deposits attributed to the scale components in the non-permeated water 15 using the non-permeated water 15 from the reverse osmosis membrane device 14 in the desalination treatment device 10A in Example 1 and prevents biofouling caused by deposits attributed from dissolved components containing organic substances or microbes in the water to be treated 11 using the water to be treated 11 before being supplied to the reverse osmosis membrane device 14 in the desalination treatment device 10C of Example 3.

In the present example, the deposition of deposits on the outlet side of the reverse osmosis membrane such as inorganic scale components in the reverse osmosis membrane in the basic design reverse osmosis membrane device 14 is predicted by measuring the permeated water flow rate of the permeated water for detection 22 using the first deposit detecting unit 24A of the present example and detecting a decrease in the permeated water flow rate using the first flow rate measuring device for permeated water for detection 41A, and the deposition of deposits on the inlet side of the reverse osmosis membrane such as biofouling caused by deposits attributed to organic components or microbes in the reverse osmosis membrane in the basic design reverse osmosis membrane device 14 is predicted by measuring the permeated water flow rate of the permeated water for detection 22 using the second deposit detecting unit 24B and detecting a decrease in the permeated water flow rate using the second flow rate measuring device for permeated water for detection 41C.

Meanwhile, in FIG. 29, out of the operation controls illustrated in FIG. 28, an example of the addition of the agglomerating agent 53 and the bactericidal agent 56 is illustrated, but other operation controls as illustrated in FIG. 28 may be carried out.

In addition, when the deposition of deposits in the reverse osmosis membrane in the basic design reverse osmosis membrane device 14 is predicted, one or both of execution of a washing treatment on the reverse osmosis membrane in the basic design reverse osmosis membrane device 14 and a change to operation conditions not allowing deposits to be deposited in the desalination treatment device are carried out using the control device 45. Therefore, it is possible to carry out stable operation in which deposits are not deposited in the reverse osmosis membrane in the basic design reverse osmosis membrane device 14.

### Example 5

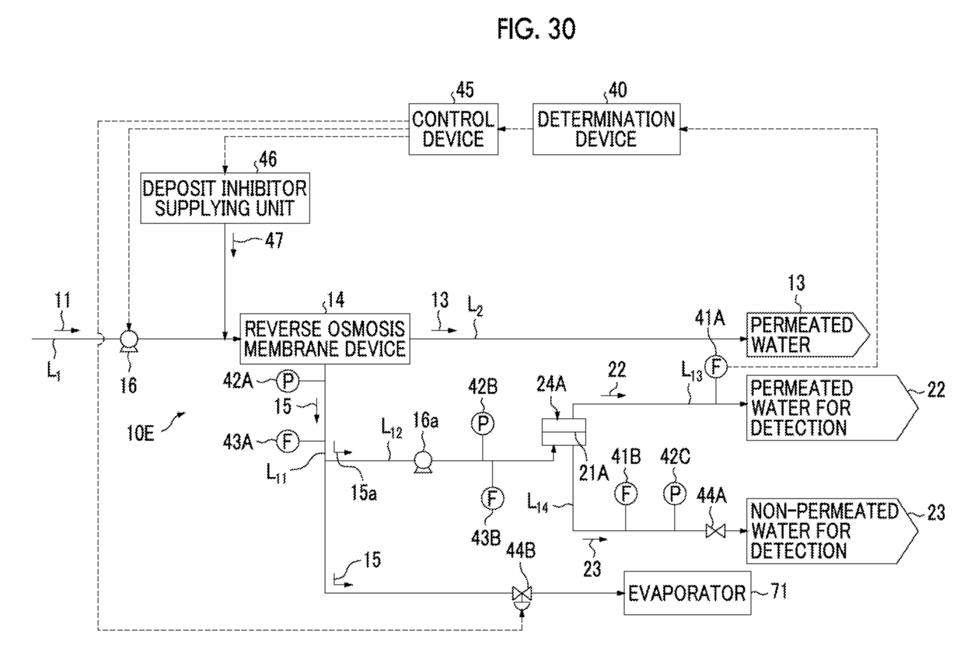

FIG. 30 is a schematic view of a desalination treatment device according to Example 5. Meanwhile, the same members as those in Example 1 will be given the same reference signs and will not be described again.

In the present example, as illustrated in FIG. 30, in a desalination treatment device 10E of the present example, an evaporator 71 for further concentrating the non-permeated water 15 from the reverse osmosis membrane device 14 in the desalination treatment device 10A of Example 1 is installed in the non-permeated water line L₁₁.

The evaporator 71 enables the removal of moisture from the non-permeated water 15 and, furthermore, also enables the collection of solid included in the non-treating water 15.

In the present example, since it is possible to carry out marginal concentration in the reverse osmosis membrane in the reverse osmosis membrane device 14 when the operation is controlled using the first deposit detecting unit 24A having the first reverse osmosis membrane for detection 21A, it is possible to significantly reduce the volume of the non-permeated water 15.

That is, as described in Example 1, the deposit deposition tolerance is obtained, the operation of the reverse osmosis membrane device 14 is controlled using this deposit deposition tolerance, and the reverse osmosis membrane device is operated under an operation condition with the marginal tolerance at which deposits are not deposited, whereby it is possible to improve the treatment efficiency of the basic design reverse osmosis membrane device 14 or reduce the treatment costs, and the volume of the non-permeated water 15 is reduced, and thus it is possible to reduce the treatment costs relating to the evaporator.

Here, examples of the evaporator 71 include evaporation devices that evaporate moisture, distillation devices, crystallization devices, zero water discharge devices, and the like.

### REFERENCE SIGNS LIST

10A TO 10E DESALINATION TREATMENT DEVICE
11 WATER TO BE TREATED
13 PERMEATED WATER
14 REVERSE OSMOSIS MEMBRANE DEVICE
15 NON-PERMEATED WATER
L₁₁ NON-PERMEATED WATER LINE
L₁₂ NON-PERMEATED WATER BRANCH LINE
L₂₁ WATER TO BE TREATED BRANCH LINE
21A FIRST REVERSE OSMOSIS MEMBRANE FOR DETECTION
21B SECOND REVERSE OSMOSIS MEMBRANE FOR DETECTION
22 PERMEATED WATER FOR DETECTION
23 NON-PERMEATED WATER FOR DETECTION
24A FIRST DEPOSIT DETECTING UNIT
24B SECOND DEPOSIT DETECTING UNIT
40 DETERMINATION DEVICE
41A FIRST FLOW RATE MEASURING DEVICE FOR PERMEATED WATER FOR DETECTION
41B FIRST FLOW RATE MEASURING DEVICE FOR NON-PERMEATED WATER FOR DETECTION
41C SECOND FLOW RATE MEASURING DEVICE FOR PERMEATED WATER FOR DETECTION
41D SECOND FLOW RATE MEASURING DEVICE FOR NON-PERMEATED WATER FOR DETECTION
45 CONTROL DEVICE

1. A deposit monitoring device for a water treatment device comprising:
a non-permeated water line for discharging non-permeated water in which dissolved components and dispersed components are concentrated from a separation membrane device for obtaining permeated water by concentrating the dissolved components and dispersed components from water to be treated by means of a separation membrane;
a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection;
a deposition condition altering device for altering deposition conditions for deposits in the first separation membrane for detection; and
first flow rate measuring devices for separated liquid for detection that measure the flow rates of one or both of the permeated water for detection and the non-permeated water for detection separated by the first separation membrane for detection.

2. A deposit monitoring device for a water treatment device comprising:
a water to be treated supply line for supplying water to be treated to a separation membrane device for obtaining permeated water by concentrating the dissolved components and dispersed components by means of a separation membrane;
a second deposit detecting unit provided in a branch line branched from the water to be treated supply line, using part of the water to be treated that has branched off as a detection liquid, and having a second separation membrane for detection in which the detection liquid is separated into permeated water for detection and non-permeated water for detection;
a deposition condition altering device for altering deposition conditions for deposits in the second separation membrane for detection; and
second flow rate measuring devices for separated Liquid for detection that measure the flow rates of one or both of the permeated water for detection and the non-permeated water for detection separated by the second separation membrane for detection.

3. The deposit monitoring device for a water treatment device according to claim 1,
wherein the deposition condition altering device is a pressure adjusting device for altering a supply pressure of the detection liquid that has branched off.

4. The deposit monitoring device for a water treatment device according to claim 1,
wherein the deposition condition altering device is a flow rate adjusting device for altering a supply flow rate of the detection liquid that has branched off.

5. A water treatment device comprising:
a separation membrane device having a separation membrane for concentrating dissolved components and dispersed components from water to be treated and obtaining permeated water;
a non-permeated water line for discharging non-permeated water in which the dissolved components and dispersed components are concentrated from the separation membrane device;
a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection;
a deposition condition altering device for altering deposition conditions for deposits in the first separation membrane for detection;
first flow rate measuring devices for separated liquid for detection that measure the flow rates of one or both of the permeated water for detection and the non-permeated water for detection separated by the first separation membrane for detection; and
a control device for carrying out one or both of execution of, a washing treatment on, the separation membrane in the separation membrane device and a change to operation conditions not allowing deposits to be deposited in the separation membrane of the separation membrane device as a result of measurement of the first flow rate measuring devices for separated liquid for detection.

6. A water treatment device comprising:
A separation membrane device having a separation membrane for concentrating dissolved components and dispersed components from water to be treated and obtaining permeated water;
a water to be treated supply line for supplying the water to be treated to the separation membrane device;
a second deposit detecting unit provided in a water to be treated branch line branched from the water to be treated supply line, using part of the water to be treated that has branched off as a detection liquid, and having a second separation membrane for detection in which the detection liquid is separated into permeated water for detection and non-permeated water for detection;
a deposition condition altering device for altering deposition conditions for deposits in the second separation membrane for detection;
second flow rate measuring devices for separated liquid for detection that measure the flow rates of one or both of the permeated water for detection and the non-permeated water for detection separated by the second separation membrane for detection; and
a control device for carrying out one or both of execution of a washing treatment on the separation membrane in the separation membrane device and a change to operation conditions not allowing deposits to be deposited in the separation membrane of the separation membrane device as a result of measurement of the second flow rate measuring devices for separated liquid for detection.

7. A water treatment device comprising:
a separation membrane device having a separation membrane for concentrating dissolved components and dispersed components from water to be treated and obtaining permeated water;
a non-permeated water line for discharging non-permeated water in which the dissolved components and dispersed components are concentrated from the separation membrane device; a first deposit detecting unit provided in a non-permeated water branch line branched from the non-permeated water line, using part of the non-permeated water that has branched off as a detection liquid, and having a first separation membrane for detection in which the detection liquid is separated into permeated water for detection and non-permeated water for detection;
a deposition condition altering device for altering deposition conditions for deposits in the first separation membrane for detection;
first flow rate measuring devices for separated liquid for detection that measure the flow rates of one or both of the permeated water for detection and the non-permeated water for detection separated by the first separation membrane for detection;
a water to be treated supply line for supplying the water to be treated to the separation membrane device;
a second deposit detecting unit provided in a water to be treated branch line branched from the water to be treated supply line, using part of the non-permeated water that has branched off as a detection liquid, and having a second separation membrane for detection in which the detection liquid is separated into permeated water for detection and non-permeated water for detection;
a deposition condition altering device for altering deposition conditions for deposits in the second separation membrane for detection;
second flow rate measuring devices for separated liquid for detection that measure the flow rates of one or both of the permeated water for detection and the non-permeated water for detection separated by the second separation membrane for detection; and
a control device for carrying out one or both of execution of, a washing treatment on the separation membrane in the separation membrane device and a change to operation conditions not allowing deposits to be deposited in the separation membrane of the separation membrane device as a result of measurement of the first flow rate measuring devices for separated liquid for detection or the second flow rate measuring devices for separated liquid for detection.

8. The water treatment device according to claim 5, further comprising:
an evaporator for evaporating moisture of the non-permeated water from the separation membrane device.

9. An operating method for a water treatment device, comprising:
carrying out one or both of execution of a washing treatment on a separation membrane in a separation membrane device and a change to operation conditions not allowing deposits to be deposited in the separation membrane of the separation membrane device, in a case in which deposition conditions for deposits in a first separation membrane for detection are changed and a flow rate of permeated water for detection or non-permeated water for detection changes more than a predetermined amount, when the permeated water for detection or the non-permeated water for detection separated by the first separation membrane for detection is measured in first flow rate measuring devices for separated liquid for detection using the deposit monitoring device for a water treatment device of claim 1.

10. The operating method for a water treatment device according to claim 9,
wherein the change of the deposition conditions for deposits is a change of a supply pressure of the non-permeated water that has branched off, and the supply pressure is equal to or less than a predetermined threshold value.

11. The operating method for a water treatment device according to claim 9,
wherein the change of the deposition conditions for deposits is a change of a supply flow rate of the non-permeated water that has branched off, and the supply flow rate is equal to or more than a predetermined threshold value.

12. An operating method for a water treatment device, comprising:
carrying out one or both of execution of a washing treatment on a separation membrane in a separation membrane device and a change to operation conditions not allowing deposits to be deposited in the separation membrane of the separation membrane device, in a case in which deposition conditions for deposits in a second separation membrane for detection are changed and a flow rate of permeated water for detection or non-permeated water for detection changes more than a predetermined amount, when the permeated water for detection or the non-permeated water for detection separated by, the second separation membrane for detection is measured in second flow rate measuring devices for separated liquid for detection using the deposit monitoring device for a water treatment device of claim 2.

13. The operating method for a water treatment device according to claim 12,
wherein the change of the deposition conditions for deposits is a change of a supply pressure of the water to be treated that has branched off, and the supply pressure is equal to or less than a predetermined threshold value.

14. The operating method for a water treatment device according to claim 12,
wherein the change of the deposition conditions for deposits is a change of a supply flow rate of the water to be treated that has branched off and the supply flow rate is equal to or more than a predetermined threshold value.

15. An operating method for a water treatment device, comprising:
carrying out a change of operation conditions for a separation membrane device, in a case in which deposition conditions for deposits in a first separation membrane for detection are changed and a flow rate of permeated water for detection or non-permeated water for detection is maintained at a predetermined amount, when the permeated water for detection or the non-permeated water for detection separated by the first separation membrane for detection is measured in first flow rate measuring devices for separated liquid for detection using the deposit monitoring device for a water treatment device of claim 1.

16. The operating method for a water treatment device according to claim 15,
wherein a change in the deposition condition for deposits is a change of a supply pressure of the non-permeated water that has branched off, and the supply pressure is equal to or more than a predetermined threshold value.

17. The operating method for a water treatment device according to claim 15,
wherein a change in the deposition condition for deposits is a change of a supply flow rate of the non-permeated water that has branched off, and the supply flow rate is equal to or less than a predetermined threshold value.

18. An operating method for a water treatment device, comprising:
carrying out a change of operation conditions for a separation membrane device, in a case in which deposition conditions for deposits in a second separation membrane for detection are changed and a flow rate of permeated water for detection or non-permeated water for detection is maintained at a predetermined amount, when the permeated water for detection or the non-permeated water for detection separated by the second separation membrane for detection is measured in second flow rate measuring devices for separated liquid for detection using the deposit monitoring device for a water treatment device of claim 2.

19. The operating method for a water treatment device according to claim 18,
wherein a change in the deposition condition for deposits is a change of a supply pressure of the non-permeated water that has branched off, and the supply pressure is equal to or more than a predetermined threshold value.

20. The operating method for a water treatment device according to claim 18,
wherein a change in the deposition condition for deposits is a change of a supply flow rate of the non-permeated water that, has branched off, and the supply flow rate is equal to or less than a predetermined threshold value.

21. A washing method for a water treatment device, comprising:
selecting a washing liquid suitable to deposits deposited in a first separation membrane for detection in a first deposit detecting unit when a flow rate of permeated water for detection and non-permeated water for detection changes more than a predetermined amount and supplying the selected washing liquid to a separation membrane device, when the permeated water for detection of the non-permeated water for detection separated by the first separation membrane for detection is measured in first flow rate measuring devices for separated liquid for detection using the deposit monitoring device for a water treatment device of claim 1.

22. A washing method for a water treatment device, comprising:
selecting a washing liquid suitable to deposits deposited in a second separation membrane for detection in a second deposit detecting unit when a flow rate of permeated water for detection and non-permeated water for detection changes more than a predetermined amount and supplying the selected washing liquid to a separation membrane device, when the permeated water for detection or the non-permeated water for detection separated by the second separation membrane for detection is measured in second flow rate measuring devices for separated liquid for detection using the deposit monitoring device for a water treatment device according to claim 2.

23. The operating method for a water treatment device according to claim 9, wherein moisture of the non-permeated water from the separation membrane device is evaporated.

24. The deposit monitoring device for a water treatment device according to claim 2,
wherein the deposition condition altering device is a pressure adjusting device for altering a supply pressure of the detection liquid that has branched off.

25. The deposit monitoring device for a water treatment device according to claim 2,
wherein the deposition condition altering device is a flow rate adjusting device for altering a supply flow rate of the detection liquid that has branched off.

26. The water treatment device according to claim 6, further comprising:
an evaporator for evaporating moisture of the non-permeated water from the separation membrane device.

27. The water treatment device according to claim 7, further comprising:
an evaporator for evaporating moisture of the non-permeated water from the separation membrane device.
